(19) United States
(12) Patent Application Publication
(10) Pub. No.: US 2024/0244595 A1
(43) Pub. Date: Jul. 18, 2024

(54) ENHANCED UPLINK TRANSMISSION USING MULTIPLE CODEWORDS

(71) Applicant: Intel Corporation, Santa Clara, CA (US)

(72) Inventors: Guotong WANG, Santa Clara, CA (US); Alexei DAVYDOV, Santa Clara, CA (US); Dong HAN, Santa Clara, CA (US); Bishwarup MONDAL, San Ramon, CA (US); Avik SENGUPTA, San Jose, CA (US)

(21) Appl. No.: 18/560,324

(22) PCT Filed: Oct. 31, 2022
(86) PCT No.: PCT/US2022/048467

§ 371 Date: Nov. 10, 2023

Related U.S. Application Data
(60) Provisional application No. 63/275,386, filed on Nov. 3, 2021.

(30) Foreign Application Priority Data
Dec. 16, 2021 (WO) PCT/CN2021/138666
Dec. 17, 2021 (WO) PCT/CN2021/139189

(51) Int. Cl. H04W 72/044

(52) U.S. Cl. CPC H04W 72/044

(57) ABSTRACT

Systems, apparatuses, methods, and computer-readable media are provided for simultaneous uplink transmission from a user equipment (UE) using multiple antenna panels and/or targeting multiple transmission-reception points (TRPs). For example, techniques for codebook-based and/or non-codebook based transmission from multiple antenna panels are described. Embodiments further include techniques for codebook subset configuration. Furthermore, embodiments include techniques for power control and/or power sharing for transmissions from a UE to multiple TRPs. Other embodiments may be described or claimed.

### CROSS REFERENCE TO RELATED APPLICATION

The present application claims priority to U.S. Provisional Patent Application No. 63/275,386, which was filed Nov. 3, 2021; International Patent Application No. PCT/CN2021/138666, which was filed Dec. 16, 2021; and to International Patent Application No. PCT/CN2021/139189, which was filed Dec. 17, 2021.

### FIELD

Various embodiments generally may relate to the field of wireless communications. For example, some embodiments may relate to enhanced uplink transmission from multiple antenna panels and/or using multiple codewords.

### BACKGROUND

In 3GPP New Radio (NR) Release (Rel)-15 and Rel-16, for uplink physical uplink shared channel (PUSCH) transmission, two schemes are defined, codebook based transmission and non-codebook based transmission.

For codebook based transmission, the user equipment (UE) is configured with one sounding reference signal (SRS) resource set that includes one or multiple SRS resources. The ‘usage’ of the SRS resource set is set to ‘codebook’. The next generation Node B (gNB) could send downlink control information (DCI) including uplink grant to schedule PUSCH transmission. In the uplink grant, the Transmission Precoding Matrix Index (TPMI) and SRS Resource Indicator (SRI) are included. In the corresponding PUSCH transmission, the UE should apply the precoder as indicated by TPMI. The number of antenna ports for PUSCH transmission is the same as the SRS resource indicated by SRI.

For non-codebook based transmission, the UE is configured with one SRS resource set that includes one or multiple SRS resources. The ‘usage’ of the SRS resource set is set to ‘nonCodebook’. And all the SRS resources are configured with only one antenna port. The gNB could indicate one or several SRIs for PUSCH transmission. The UE should select the precoder for PUSCH according to the indicated SRIs.

### BRIEF DESCRIPTION OF THE FIGURES

FIG. 1 depicts an example of codebook based and non-codebook based physical uplink shared channel (PUSCH) transmission, in accordance with various embodiments.

FIG. 2 depicts an example mapping among codeword(s), layer(s), and user equipment (UE) panels, in accordance with various embodiments.

FIG. 3 depicts an example of frequency division multiplexed (FDMed) transmission from multiple UE panels, in accordance with various embodiments.

FIG. 4 depicts an example of a codebook subset with maxRank=1, in accordance with various embodiments.

FIG. 5 depicts an example of a codebook subset with maxRank=2, in accordance with various embodiments.

FIG. 6 illustrates an example of semi-static equal power sharing between transmissions to multiple transmission-reception points (TRPs), in accordance with various embodiments.

FIG. 7 illustrates an example of semi-static unequal power sharing between transmissions to multiple TRPs, in accordance with various embodiments.

FIG. 8 illustrates an example of dynamic power sharing between transmissions to multiple TRPs, in accordance with various embodiments.

FIG. 9 illustrates a network in accordance with various embodiments.

FIG. 10 schematically illustrates a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIG. 12 depicts an example procedure for practicing the various embodiments discussed herein.

FIG. 13 depicts another example procedure for practicing the various embodiments.

FIG. 14 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Various embodiments herein relate to techniques for uplink transmission from a UE using simultaneous transmission from multiple antenna panels and/or targeting multiple TRPs. For example, embodiments include techniques for codebook-based and/or non-codebook based transmission from multiple antenna panels. Embodiments further include techniques for codebook subset configuration. Furthermore, embodiments include techniques for power control and/or power sharing for transmissions from a UE to multiple TRPs.

PUSCH Transmission with Simultaneous Transmission from Multiple UE Antenna Panels

As discussed above, for codebook based transmission, the UE is configured with one sounding reference signal (SRS) resource set consisting of one or multiple SRS resources. The ‘usage’ of the SRS resource set is set to ‘codebook’. The NR base station or nodeB (gNB) could send downlink control information (DCI) including uplink grant to schedule PUSCH transmission. In the uplink grant, the Transmission Precoding Matrix Index (TPMI) and SRS Resource Indicator (SRI) are included. In the corresponding PUSCH transmission, the UE should apply the precoder as indicated by TPMI. The number of antenna ports for PUSCH transmission is the same as the SRS resource indicated by SRI.

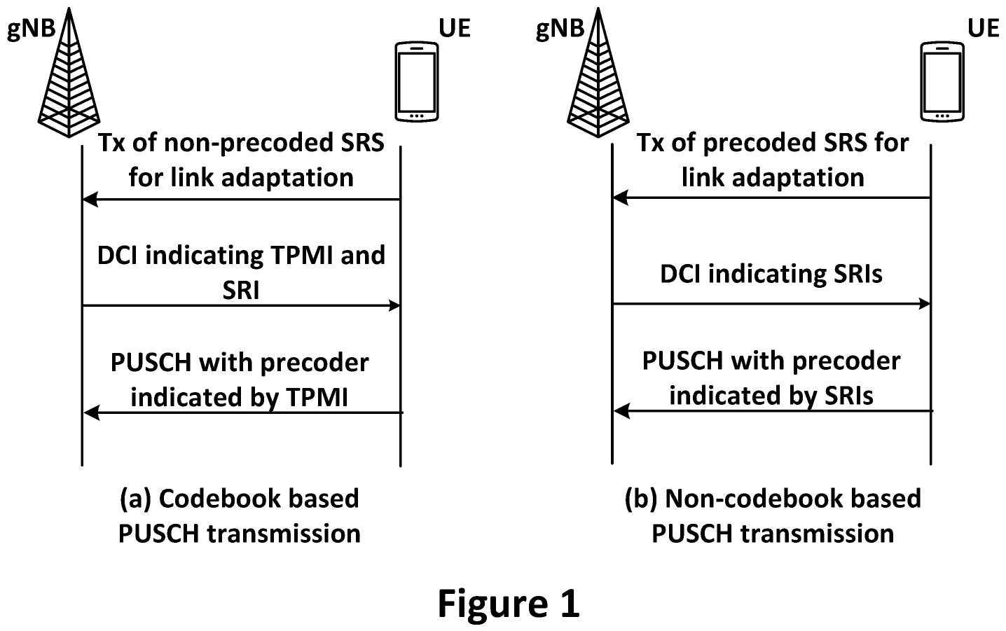

For non-codebook based transmission, the UE may be configured with one SRS resource set that may include of one or multiple SRS resources. The ‘usage’ of the SRS resource set is set to ‘nonCodebook’. And all the SRS resources are configured with only one antenna port. The gNB may indicate one or several SRIs for PUSCH transmission. The UE may then select the precoder for PUSCH according to the indicated SRIs. FIG. 1 shows an example operation of codebook based and non-codebook based PUSCH transmission.

In Rel-18, the simultaneous uplink transmission from multiple UE antenna panels will be supported. Therefore, it may be desirable to enhance the PUSCH transmission, such as the SRI, TPMI, spatial relations, etc. For example, legacy PUSCH transmission schemes may not consider simultaneous transmission from multiple UE antenna panels. Therefore, embodiments herein relate to support of an enhanced PUSCH transmission scheme with multiple simultaneously active UE antenna panels.

### Enhanced PUSCH Transmission

In an embodiment, for a UE supporting simultaneous uplink transmission from multiple panels, the uplink transmission from multiple UE antenna panels could be time division multiplexed (TDMed), frequency division multiplexed (FDMed), or space division multiplexed (SDMed) (or the multiplexing method could be combined, for example, TDMed+FDMed).

For reliability enhancement, the PUSCH may be transmitted as repetitions from multiple panels, e.g., the same payload is transmitted over multiple panels. For throughput enhancement, the same or different PUSCH payload may be transmitted from multiple panels.

For reliability enhancement, the same transmission block may be transmitted over different panels. For throughput enhancement, the same or different transmission block may be transmitted from multiple panels.

In an example, for single DCI multi-transmission reception point (TRP) operation, the simultaneous transmission from multiple UE panels may be performed for the purpose of reliability enhancement. For multi-DCI multi-TRP operation, the simultaneous transmission from multiple UE panels may be performed for the purpose of throughput enhancement.

### Beam Indication

In an embodiment, for UE supporting simultaneous uplink transmission from multiple panels, multiple beams (e.g., 2) could be indicated to the UE for the uplink transmission, e.g., one beam is used for the transmission from one panel.

In the DCI scheduling PUSCH transmission (e.g., DCI 0_1/0_2), two beams could be indicated. If the UE supports release 16 (Rel-16) beam indication, e.g., the beam is indicated by SRI, then two SRI fields may be included in the DCI.

If the UE supports release-17 (Rel-17) transmission configuration indicator (TCI) operation, then in the DCI scheduling PUSCH (e.g., DCI 0_1/0_2), two TCI states could be indicated by the DCI (The TCI state could be joint DL/UL TCI state or separate UL TCI state). New field(s) should be added in the DCI for TCI indication. In one example, two TCI state fields should be added to the DCI, one TCI state is for one panel. Or one TCI state field is added to the DCI wherein one codepoint of the TCI state field could indicate two TCI states, one TCI state is for one panel. In another example, in the DCI scheduling PDSCH (e.g., DCI 0_1/0_2), two TCI states could be indicated by the DCI. Two TCI state fields could be included in the DCI, or one TCI state field is included in the DCI and one codepoint of the TCI state field could indicate two TCI states.

The mapping between the beam and UE panel could be predefined or dynamically indicated. For example, the first beam (indicated by the first SRI or the first TCI state) is for the first UE panel, and the second beam is for the second UE panel. Alternatively, the mapping between beam and panel is through the PUSCH close loop power control state. For example, the first beam (indicated by the first SRI or the first TCI state) is associated with the transmission via the first PUSCH close loop power control state, and the second beam is associated with the transmission via the second PUSCH close loop power control state.

If the PUSCH is transmitted with repetition, then the mapping between the indicated beam and the repetitions could be sequential mapping, cyclic mapping or half-and-half mapping.

### Single Codeword

In an embodiment, for UE supporting simultaneous uplink transmission from multiple panels, a single codeword may be used for PUSCH.

In one example, two SRIs and two TPMIs may be indicated to the UE for codebook based transmission. One SRI/TPMI is used for the transmission from one UE panel. In the DCI, two SRI fields and two TPMI fields may be included in the DCI. For non-codebook based transmission, two SRI fields may be included in the DCI and two SRIs are indicated.

In another example, one TPMI may be indicated for the UE. Different layers of the indicated TPMI may be be transmitted over different panels. The mapping between layers and UE antenna panels may be pre-defined or dynamically indicated.

### Multiple Codewords

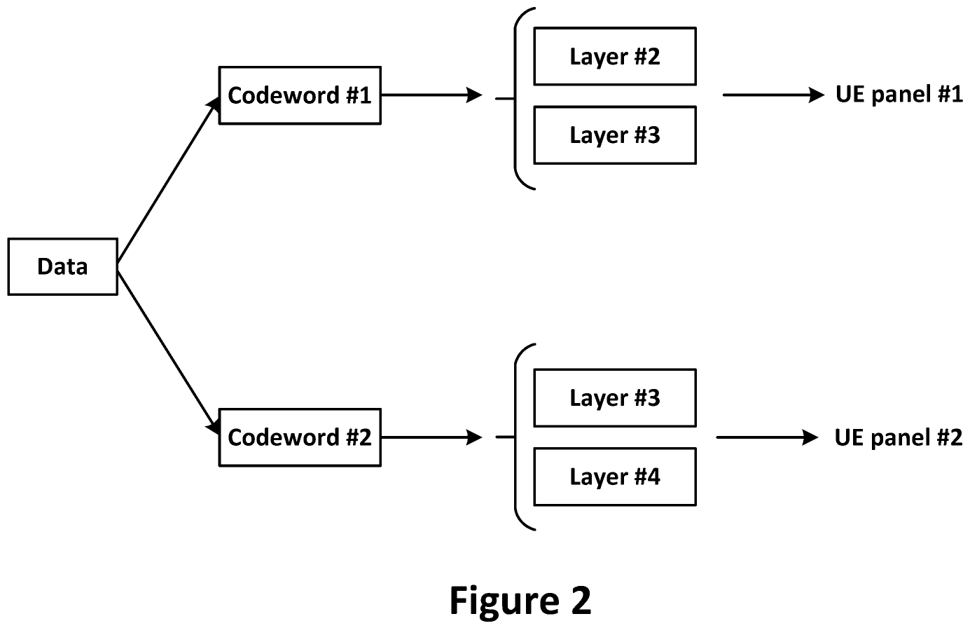

In an embodiment, for UE supporting simultaneous uplink transmission from multiple panels, multiple codewords, e.g., 2 codewords, could be used for PUSCH. One codeword is used for the transmission over one UE panel. FIG. 2 shows an example of the mapping among codeword, layers and UE panels. In the example, the layers are equally distributed among codewords/panels (two layers per codeword). In another example, whether the layers are equally distributed among codewords could be configured.

In the DCI two SRIs (for both codebook and non-codebook based transmission) and two TPMIs (for codebook based transmission) are indicated. Two SRI fields and two TPMI fields could be included in the DCI.

The mapping among codeword, SRI/TPMI, and UE antenna panel may be predefined or dynamically indicated.

### Resource Allocation

In an embodiment, for the transmission over multiple UE panels, the same frequency/time resource or different frequency/time resource could be used for the transmission over different UE panels.

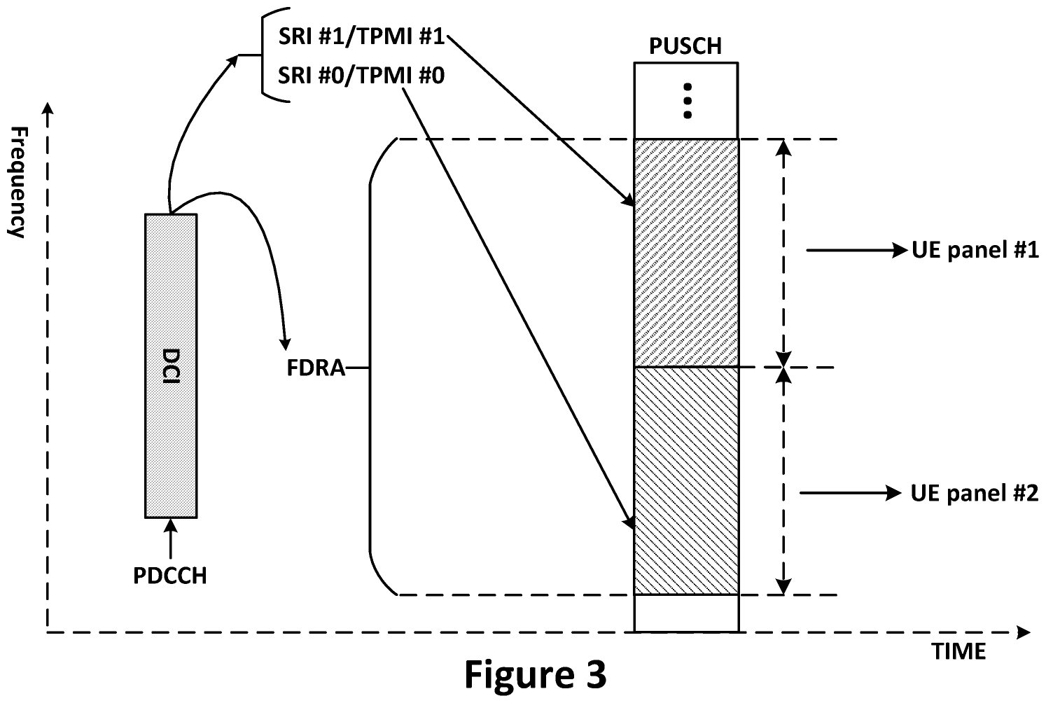

For FDMed transmission from multiple panels, different frequency resources may be utilized for the transmission over different panel (or the frequency resources are partially overlapped). One or two frequency division resource allocation (FDRA) could be indicated by the DCI. One FDRA field could be included in the DCI or two FDRA fields are included in the DCI. Or one FDRA field I is included in the DCI and one codepoint can indicate two FDRA. If two FDRA are indicated by the DCI, then one FDRA is used for the transmission over one panel. If one FDRA is indicated by the DCI, then different parts of the indicated frequency resource are used for different panels. For example, the indicated frequency resources are split into two parts equally; the first part is used for the first panel and the second part is used for the second panel. FIG. 3 shows an example of the operation.

For TDMed transmission from multiple panels, different time resources are utilized for the transmission over different panel (or the time resources are partially overlapped). One or two time division resource allocation (TDRA) could be indicated by the DCI. One TDRA field could be included in the DCI or two TDRA fields are included in the DCI. Or one TDRA field is included in the DCI and one codepoint can indicate two TDRA. If two TDRA are indicated by the DCI, then one TDRA is used for the transmission over one panel. If one TDRA is indicated by the DCI, then different parts of the indicated time resource are used for different panels. For example, the indicated time resources are split into two parts equally; the first part is used for the first panel and the second part is used for the second panel.

For SDMed transmission from multiple panels, the same frequency/time resources are used for the transmission from different panels. Only one FDRA/TDRA is needed. Or the frequency/time resources for different panels could be partially overlapped. In such case, two FDRA/TDRA are indicated.

In another embodiment, for the transmission from multiple UE panels, the same modulation coding scheme (MCS)/new data indicator (NDI)/redundancy version (RV) may be applied to the transmission from different panel. Or different MCS/NDI/RV could be used for the transmission from different panel.

In the DCI format scheduling PUSCH transmission, it may include multiple of one or more of the following fields:
Multiple MCS fields, for example, two MCS fields. The first MCS field is applied to the first codeword, the second MCS field is applied to the second codeword.
Multiple NDI fields, for example, two NDI fields. The first NDI field is applied to the first codeword, the second NDI field is applied to the second codeword.
Multiple RV fields, for example, two RV fields. The first RV field is applied to the first codeword, the second RV field is applied to the second codeword.

### Panel Identification

In an embodiment, for the transmission from multiple UE panels, the demodulation reference signal (DMRS) port group could be introduced to identify UE antenna panel. For example, two PUSCH DMRS port groups are supported, and one DMRS port group is associated with one UE panel.

Or the UE antenna panel could be associated with spatial relation or TCI state.

Or the UE antenna panel could be associated with PUSCH close loop power control state.

Or different SRS resource set could be configured for different UE panel. And the UE panel is identified by the associated SRS resource set. Or the UE antenna panel could be associated with different SRI.

It will be noted that various embodiments herein may be applied for multi-panel transmission in single TRP and multi-TRP (including single DCI and multi-DCI). All the embodiments could be applied to cyclic prefix orthogonal frequency division multiplexed (CP-OFDM) and/or discrete fourier transform-spread-orthogonal frequency division multiplexed (DFT-s-OFDM) waveform. All the embodiments could be applied for codebook based transmission and non-codebook based transmission.

### Enhanced Codebook Subset Configuration

Codebook-based transmission mode (e.g., of PUSCH) was designed considering different user equipment (UE) coherence capabilities, e.g., whether a UE can maintain the relative phase among all (full coherence), or a subset (partial coherence), or none (non-coherence) of the transmit chains/antenna ports over time.

In Rel-15, the UE may be configured to operate with a subset of precoders in the uplink (UL) codebook according to the reported coherence capability. Note that, in the 3GPP specification, full coherence, partial coherence, and non-coherent UE capabilities are identified as ‘fullAndPartialAndNonCoherent’, ‘partialAndNonCoherent’, and ‘nonCoherent’. A UE capable of ‘fullAndPartialAndNonCoherent’ transmission can be configured with codebook subset of ‘fullAndPartialAndNonCoherent’, ‘partialAndNonCoherent’, or ‘nonCoherent’. A UE capable of ‘partialAndNonCoherent’ transmission can be configured with codebook subset of ‘partialAndNonCoherent’, or ‘nonCoherent’.

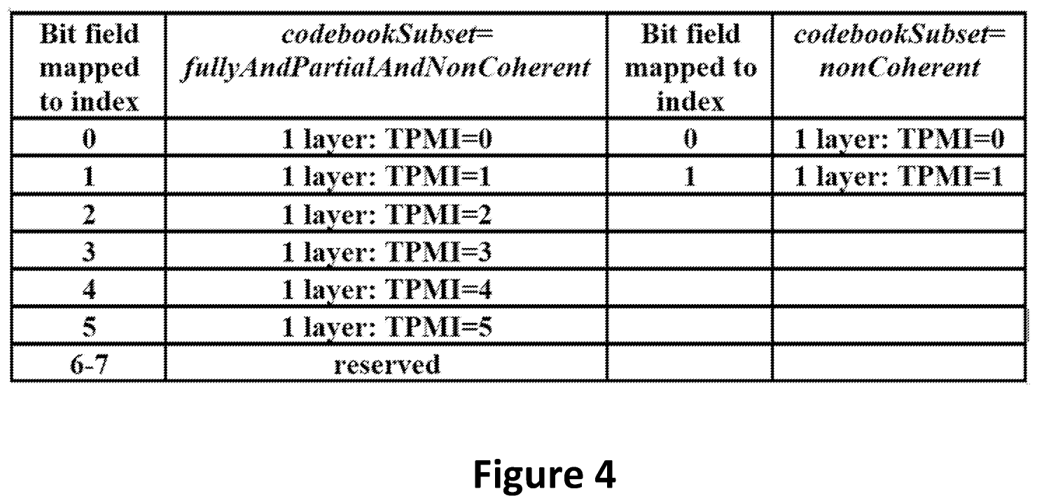

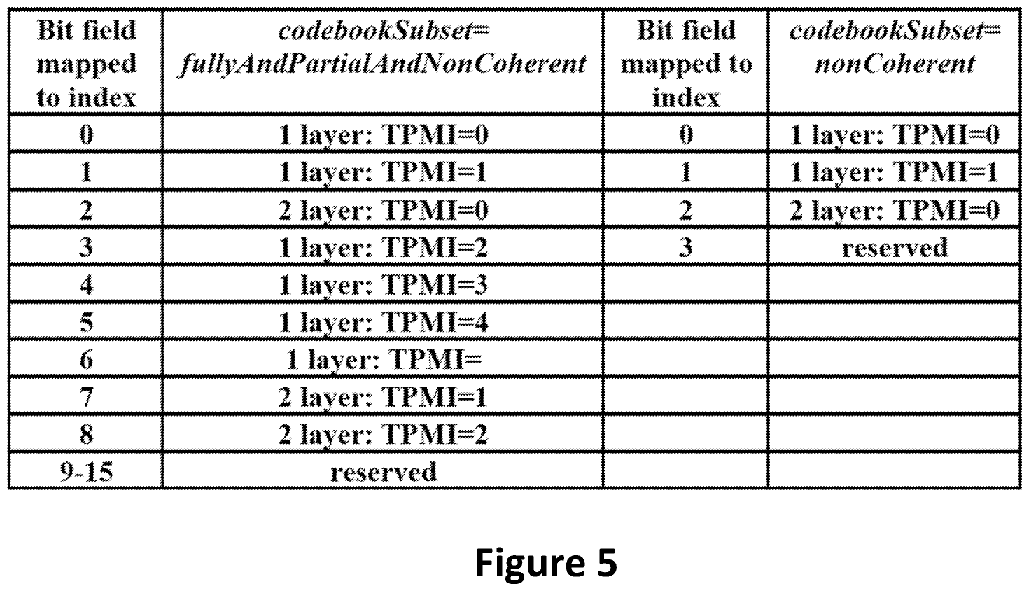

In radio resource control (RRC), there is a parameter maxRank which may configure the maximum number of layers (ranks) for PUSCH transmission. In the release-16 (Rel-16) specification, the value of maxRank is set to be the same as maxMIMO-Layers, and the value range is 1 to 4, indicating that the current codebook subset configuration may only support 4 layers. FIG. 4 and FIG. 5 show examples on the codebook subset with different value of maxRank.

In Rel-18, the PUSCH transmission may support up to 8 layers, and a single codeword or multiple codewords may be used. In addition, simultaneous uplink transmission from multiple UE panels will be supported. Therefore, the codebook subset should be enhanced accordingly. Embodiments herein relate to codebook subset configuration to support up to 8 layers and multiple codewords/UE antenna panels.

### Uplink Transmission Up to 8 Layers

### Single Codeword

In an embodiment, for uplink transmission up to 8 Tx (e.g., using up to 8 layers), if a single codeword is used, the value of RRC parameter maxRank may be extended up to 8. Correspondingly, the value of maxMIMO-Layers may also be extended to 8. Only one maxRank parameter (also only one maxMIMO-Layers) may be configured to the UE, and only one codebook subset may be configured to the UE.

### Multiple Codewords

In an embodiment, for uplink transmission up to 8 Tx, if multiple codewords (e.g., 2) are used, then two RRC parameters maxRank (also two maxMIMO-Layers) may be configured, one for each codeword. The value of the two maxRank parameters (and two maxMIMO-Layers) may be the same or different.

Alternatively, only one maxMIMO-Layers may be configured, which may indicate the maximum number of multiple input/multiple output (MIMO) layers across all the codewords (or which may be indicated by a new RRC parameter). The parameter maxRank may be used to indicate the maximum number of layers for each codeword (or it is indicated by a new RRC parameter), and the value of maxRank may be be equal to or smaller than maxMIMO-Layers. One or two maxRank may be configured. If only one maxRank is configured, then it may apply to all the codewords. If two maxRank are configured, then one is used for each codeword, and the value of the two maxRank may be the same or different.

Two codebook subsets may be configured to the UE, one for each codeword. The same or different codebook subset may be configured for different codewords. The type of the codebook subset (full coherent, partial coherent, non-coherent) could be the same or different for different codeword.

Alternatively, only one codebook subset may be configured to the UE, which is applicable for all the codewords.

In another embodiment, the number of antenna ports may be the same or different for different codewords.

In another embodiment, for uplink transmission up to 8 Tx, if multiple codewords (e.g., 2) are used, then only one RRC parameter maxRank (also only one maxMIMO-Layers) may be configured, which is used for all the codewords. And only one codebook subset may be configured to the UE, which is used for all the codewords.

In one example, the parameter maxMIMO-Layers may indicate the maximum number of MIMO layers across all the codewords (or it is indicated by anew RRC parameter). The parameter maxRank is used to indicate the maximum number of layers per codeword (or it is indicated by a new RRC parameter). The value of maxRank could be equal to or smaller than maxMIMO-Layers.

Simultaneous Transmission from Multiple UE Panels

In an embodiment, for a UE supporting simultaneous uplink transmission from multiple UE panels (e.g., 2 panels), two RRC parameters maxRank (also two maxMIMO-Layers) may be configured, one for each panel (or one for each codeword, if two codewords are used). The value of the two maxRank parameters (and two maxMIMO-Layers) may be the same or different.

Alternatively, only one maxMIMO-Layers may be configured, which may indicate the maximum number of MMO layers across all the panels/codewords (or it is indicated by a new RRC parameter). The parameter maxRank may be used to indicate the maximum number of layers for each panel/codeword (or it may be indicated by a new RRC parameter), and the value of maxRank may be equal to or smaller than maxMIMO-Layers. One or two maxRank may be configured. If only one maxRank is configured, then it applies to all the panels/codewords. If two maxRank are configured, then one is used for each panel/codeword, and the value of the two maxRank could be the same or different.

Two codebook subsets may be configured to the UE, one for each panel (or one for each codeword, if two codewords are used). The same or different codebook subset may be configured for different panel/codeword. The type of the codebook subset (full coherent, partial coherent, non-coherent) may be the same or different for different panel/codeword.

Alternatively, only one codebook subset is configured to the UE, which may be applicable for all the panels.

In another embodiment, the number of antenna ports may be the same or different for different panel/codeword.

In another embodiment, for a UE supporting simultaneous uplink transmission from multiple UE panels (e.g., 2 panels), only one RRC parameter maxRank (also only one maxMIMO-Layers) may be configured, which is used for all the panels/codewords. And only one codebook subset is configured to the UE, which is used for all the panels/codewords.

In one example, the parameter maxMIMO-Layers may indicate the maximum number of MIMO layers across all the panels/codewords (or it may be indicated by a new RRC parameter). The parameter maxRank is used to indicate the maximum number of layers per panel/codeword (or it is indicated by a new RRC parameter). The value of maxRank could be equal to or smaller than maxMIMO-Layers.

### Power Control for Multi-TRP Simultaneous Uplink Channel Transmission

In Rel-15/Rel-16, the uplink (UL) power control is applied to PUSCH, PUCCH, and SRS transmissions to adjust the UL transmit power.

The UE determines the PUSCH transmission power as

$${P}_{PUSCH , b , f , c} ( i , j , {q}_{d ,} l ) = m in \{ \begin{matrix}{P}_{CMAX , f , c} ( i ) \\ {P}_{0 \_ PUSCH , b , f , c} ( j ) + 10 {log}_{10} ( {2}^{μ} \cdot {M}_{RB , b , f , c}^{P U S C H} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ] , \qquad ( 1 )$$

where the parameters' meanings are as below:
b: UL BWP index
f: Carrier index
C: Serving cell
j: Parameter set configuration index
l: PUSCH power control adjustment state index
i: PUSCH transmission occasion
q_{d}: Reference signal index used for pathloss calculation, corresponding to different beam

Generally, each component in the formula has the following meaning:
P_{CMAX}: The UE maximum output power
P_{O_PUSCH}: The target received PUSCH power
M: Bandwidth in number of resource blocks
α: Pathloss compensation factor
PL: Pathloss (beam specific)
Δ: Adjustment according to MCS
f_{b,f,c}(i,l): Adjustment according to TPC command from gNB

Similarly, for PUCCH and SRS, the transmission powers are determined as follows.

$${P}_{PUCCH , b , f , c} ( i , {q}_{u} , {q}_{d} , l ) = min \{ \begin{matrix}{P}_{CMAX , f , c} ( i ) \\ {P}_{0 \_ PUCCH , b , f , c} ( {q}_{u} ) + 10 {log}_{10} ( {2}^{μ} \cdot {M}_{RB , b , f , c}^{PUCCH} ( i ) ) + {PL}_{b , f , c} ( {q}_{d} ) + {Δ}_{{F}_{PUCCH}} ( F ) + {Δ}_{TF , b , f , c} ( i ) + {g}_{b , f , c} ( i , l )\end{matrix} \} [ dBm ] , \qquad ( 2 )$$

$${P}_{SRS , b , f , c} ( i , {q}_{s} , l ) = min \{ \begin{matrix}{P}_{CMAX , f , c} ( i ) \\ {P}_{0 \_ SR S , b , f , c} ( {q}_{s} ) + 10 {log}_{10} ( {2}^{μ} \cdot {M}_{SRS , b , f , c} ( i ) ) + {α}_{SRS , b , f , c} ( {q}_{s} ) \cdot {PL}_{b , f , c} ( {q}_{d} ) + {h}_{b , f , c} ( i , l )\end{matrix} \} [ dBm ] . \qquad ( 3 )$$

As indicated above, P_{CMAX,f,c}(i) is the maximum UE transmission power in a certain frequency/time domain (e.g., for serving cell c, carrier index f, and transmission occasion i).

Rel-17 NR supports multi-TRP PUSCH/PUCCH repetitions/transmissions, which means the same UL data or control information can be transmitted to multiple TRPs as multiple repetitions/transmissions in multiple time slots or sub-slots. However, in each time slot or sub-slot, there can be only one UL transmission occasion towards a certain TRP. To utilize the multiple TRPs more efficiently, Rel-18 5G NR system may support simultaneous multi-TRP (transmission reception point) transmission schemes in UL. In particular, to increase the overall capacity and to increase robustness of the transmission to potential blockage of the channel, UE could transmit signal targeting two or more TRPs simultaneously.

Rel-15/Rel-16 UL power control is for the scenario where the transmission is towards one TRP in a certain frequency/time domain but not the scenario where the transmission is towards multiple TRPs simultaneously. To support multi-TRP (mTRP) simultaneous UL transmission, the power control for each transmission occasion towards a TRP should be properly designed. And the total transmission power at any time should not beyond the maximum UE transmission power limit. Accordingly, various embodiments herein provide techniques for power control for mTRP simultaneous UL transmission.

As mentioned above, in multi-TRP simultaneous UL transmission, two transmission occasions (TOs) can be overlapped in time domain and the UE's maximum transmission power, P_{CMAX}, is limited. Embodiments herein provide techniques for how to allocate the total maximum transmission power for the TOs which happen simultaneously. In the description of some embodiments, it may be assumed there are two TRPs, and the maximum transmission power allocated for TRP1 is P_{CMAX,1}, and the maximum transmission power allocated for TRP2 is P_{CMAX,2}. The UE may have two panels, which are used for the transmission to TRP1 and TRP2 respectively. However, the techniques may be extended to transmissions targeting more than 2 TRPs (e.g., from a corresponding number of antenna panels of the UE).

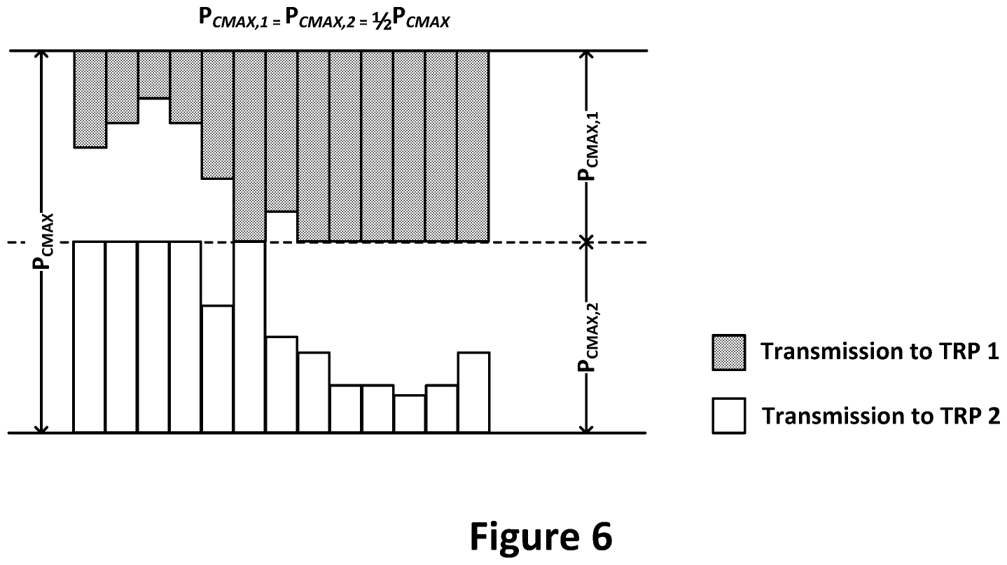

In one embodiment, semi-static equal power sharing is used. The maximum transmission powers for the two simultaneous transmissions are set separately as P_{CMAX,1} and P_{CMAX,2}. Then, for each UL TO towards a certain TRP, the power control is done individually, following the existing mechanism. As shown in FIG. 6, the UE's maximum transmission power, P_{CMAX}, is equally split for the two simultaneous transmissions, e.g.,

$${P}_{CMAX , 1} = {P}_{CMAX , 2} = \frac{1}{2} {P}_{CMAX} .$$

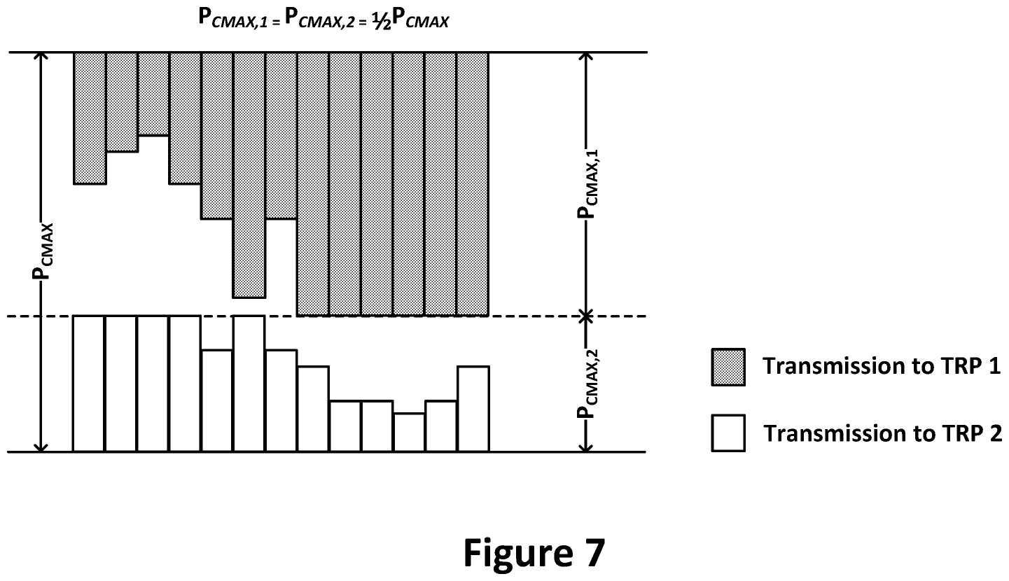

In another embodiment, semi-static unequal power sharing is used. The maximum transmission powers for the two simultaneous transmissions are set separately as P_{CMAX,1} and P_{CMAX,2}. Then, for each UL TO towards a certain TRP, the power control is done individually, following the existing mechanism. As shown in FIG. 7, the UE's maximum transmission power, P_{CMAX}, can be unequally split for the two simultaneous transmissions, e.g., P_{CMAX,1}+P_{CMAX,2}=P_{CMAX}, P_{CMAX,1}≥0, P_{CMAX,2}≥0. The relation between the value of P_{CMAX,1} and P_{CMAX,2} can be controlled by the network.

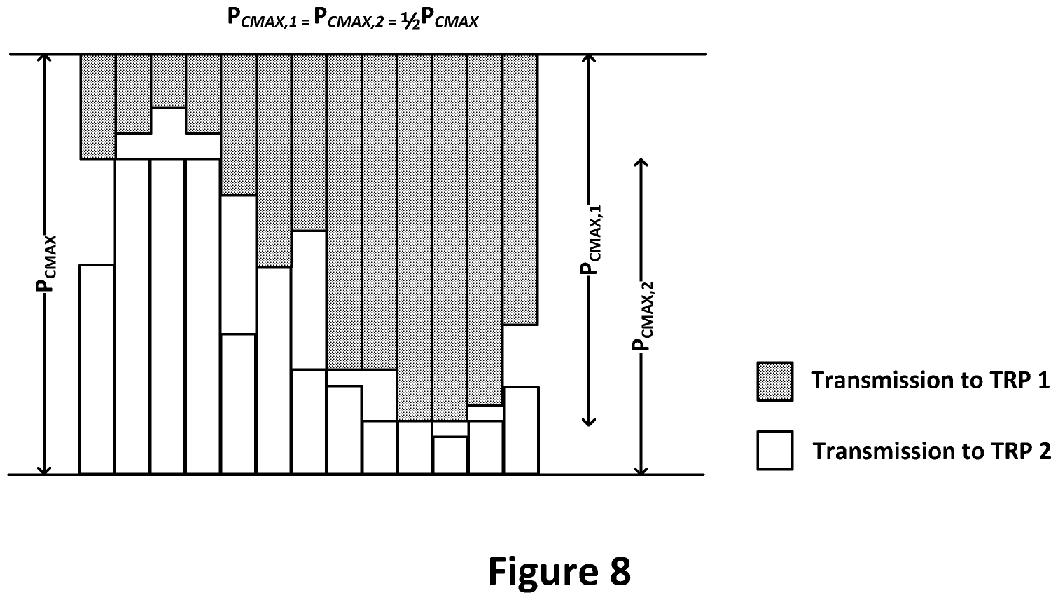

In another embodiment, dynamic power sharing is used. The maximum transmission powers for the two simultaneous transmissions are set separately as P_{CMAX,1} and P_{CMAX,2}. As shown in FIG. 8, the UE's maximum transmission power, P_{CMAX}, can be smaller than the summation of maximum transmission powers of the two TOs, e.g., P_{CMAX,1}+P_{CMAX,2}>P_{CMAX} (However, the instant total transmission power is still within the limitation of P_{CMAX}). In this mechanism, a primary TRP (without loss of generality, assuming the primary TRP is TRP1) is needed to be set, towards which the TO's transmission power is determined first. When another TO's transmission power is to be determined, it should not only be within the limitation of P_{CMAX,2}, but also not guarantee the total maximum transmission power is within P_{CMAX}. In other words, denoting P₁(i) and P₂(i) as the transmission powers of the TOs towards TRP1 and TRP2 at slot i, respectively, the determination of P₁(i) follows P₁(i)≤P_{CMAX,1}, and the determination of P₂(i) follows P₂(i)≤P_{CMAX,2} and P₁(i)+P₂(i)≤P_{CMAX}. Optionally, if the P₂(i) is reduced from a target transmission power by a value larger than a threshold in order to guarantee P₁(i)+P₂(i)≤P_{CMAX}, the UE may not transmit towards TRP2.

### Power Headroom Report for Multi-TRP Simultaneous UL Transmission

The UE should report power headroom (PHR) when the PHR report is triggered. In multi-TRP simultaneous UL transmission, the two UL transmissions can be either two PUSCH repetitions or two different PUSCH transmission occasions. There are several considerations for PHR reporting for simultaneous UL transmission. First, it is better if the gNB can know the remaining power for the transmissions towards other TRP. Second, the PHR(s) carried in the simultaneous PUSCH repetitions are better to be the same to enable soft-combination for better error performance. (Third, in multi-TRP simultaneous UL transmission scenario, if PHR is triggered, the PHR(s) should be transmitted towards which TRP.)

In one embodiment, for semi-static power sharing, if PHR is triggered in multi-TRP simultaneous UL transmission scenarios, and the simultaneous UL transmissions are PUSCH repetitions, each PUSCH repetition contains two PHRs, corresponding to the transmission towards TRP1 and TRP2.

In another embodiment, for semi-static power sharing, if PHR is triggered in multi-TRP simultaneous UL transmission scenarios, and the simultaneous UL transmissions are two PUSCH transmissions, each PUSCH transmission carries one PHR, corresponding to the transmission towards to the target TRP.

In another embodiment, for dynamic power sharing, if PHR is triggered in multi-TRP simultaneous UL transmission scenarios, all PUSCH transmissions carry the same PHR, corresponding to the total remaining transmission power at the UE.

### Systems and Implementations

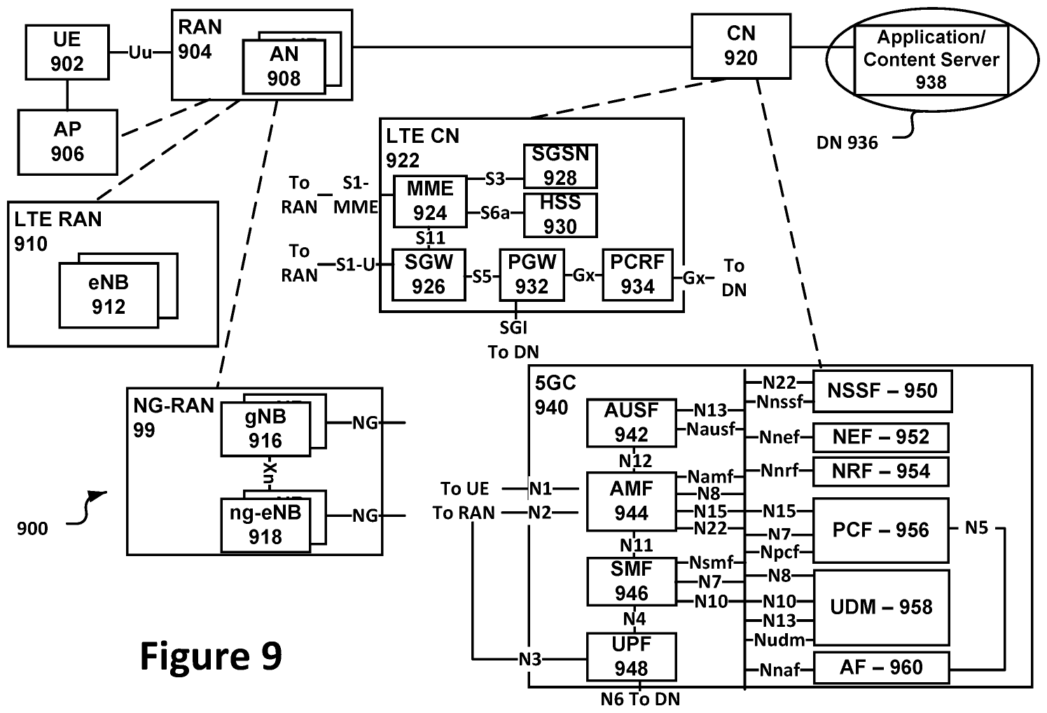

FIGS. 9-11 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 936 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3^{rd} party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

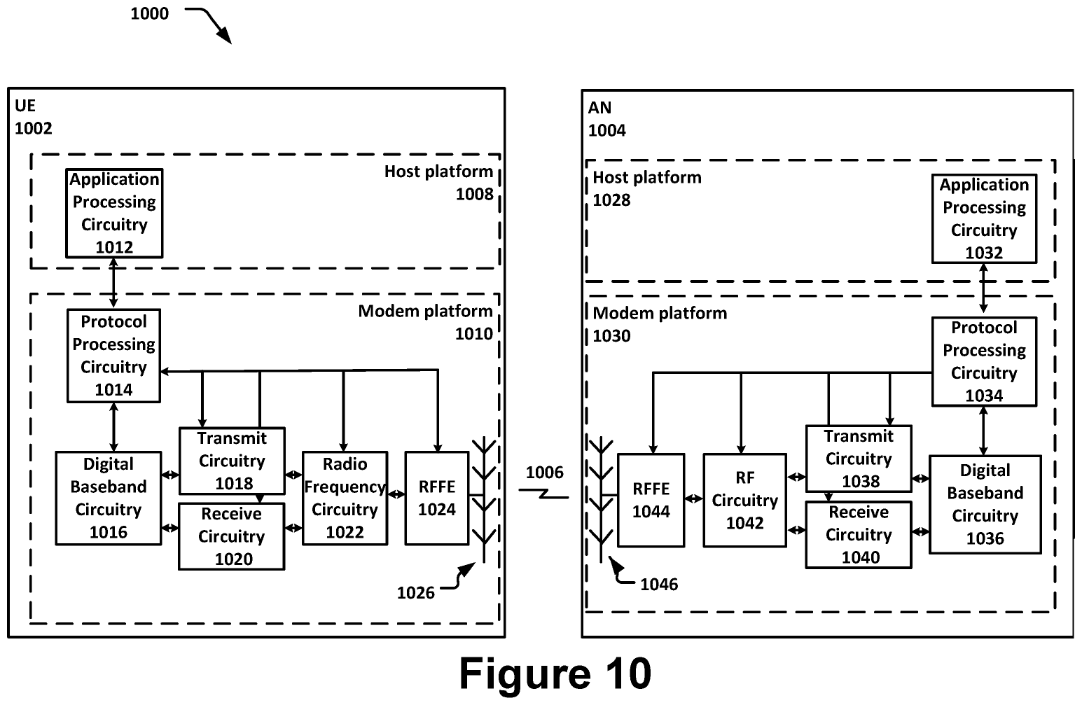

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

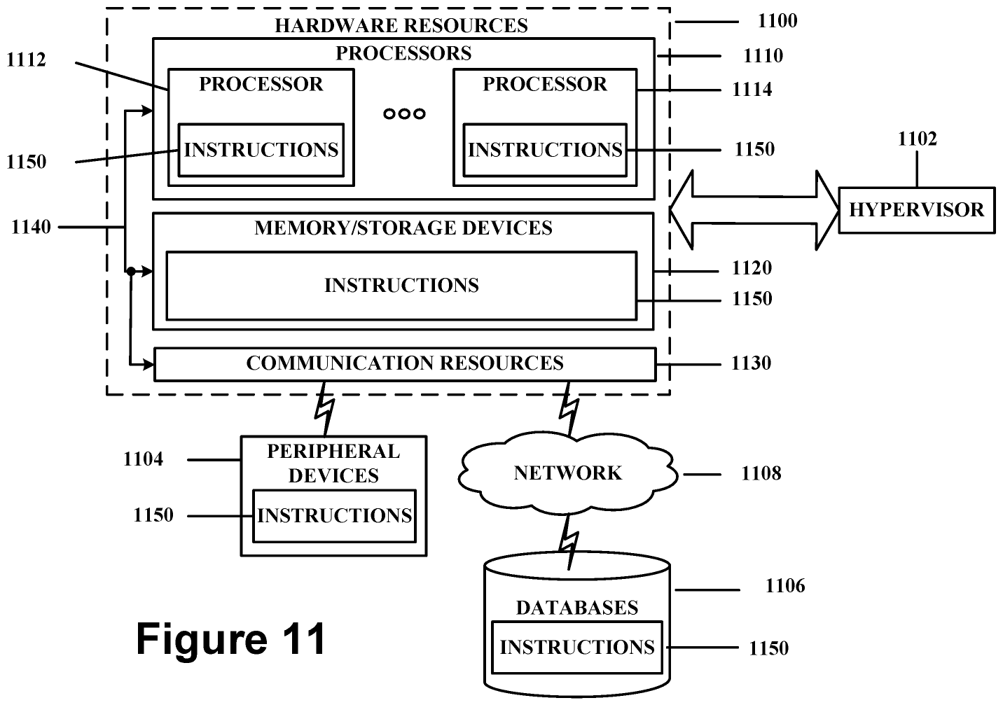

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### Example Procedures

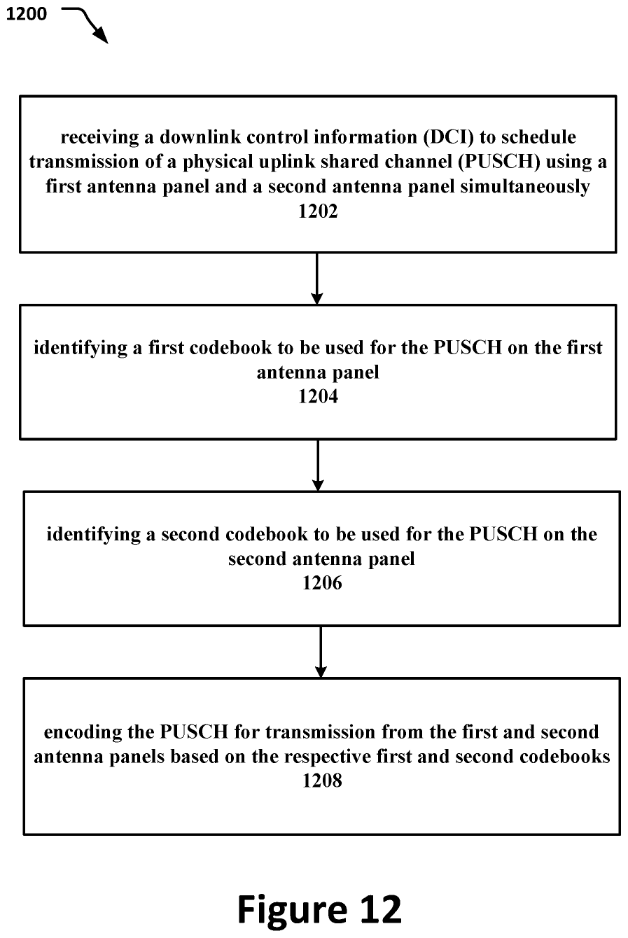

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process 1200 is depicted in FIG. 12. In some embodiments, the process 1200 may be performed by a UE or a portion thereof. At 1202, the process 1200 may include receiving a downlink control information (DCI) to schedule transmission of a physical uplink shared channel (PUSCH) using a first antenna panel and a second antenna panel simultaneously. At 1204, the process 1200 may further include identifying a first codebook to be used for the PUSCH on the first antenna panel. At 1206, the process 1200 may further include identifying a second codebook to be used for the PUSCH on the second antenna panel. At 1208, the process 1200 may further include encoding the PUSCH for transmission from the first and second antenna panels based on the respective first and second codebooks.

In various embodiments, the PUSCH transmissions on the first and second antenna panels may include the same or different payloads (e.g., data). The PUSCH transmissions may be multiplexed in at least one of time, frequency, or spatial relation. In some embodiments, the DCI may indicate respective TPMIs and/or SRIs for the transmissions on the first and second antenna panels. Additionally, or alternatively, the UE may receive configuration information for the first and second codewords. In some embodiments, the configuration information may indicate respective maximum rank (maxRank) parameters and/or subsets of precoders for the first and second codewords.

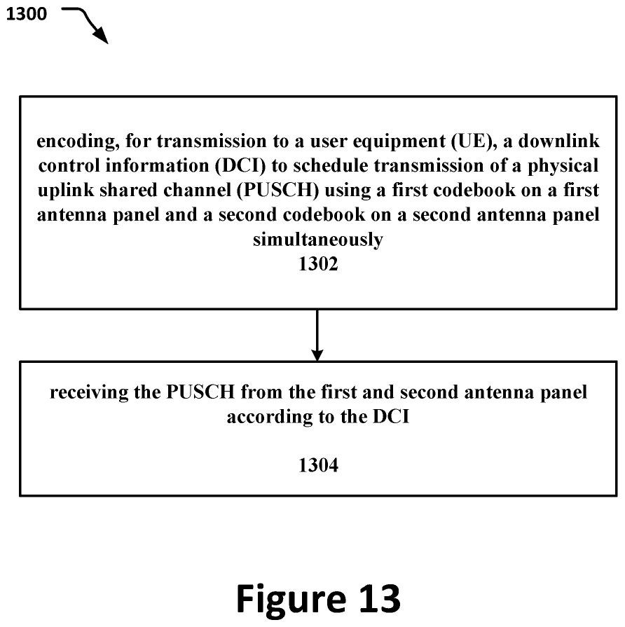

FIG. 13 illustrates another process 1300 in accordance with various embodiments. In some embodiments, the process 1300 may be performed by a gNB or a portion thereof. At 1302, the process may include encoding, for transmission to a user equipment (UE), a downlink control information (DCI) to schedule transmission of a physical uplink shared channel (PUSCH) using a first codebook on a first antenna panel and a second codebook on a second antenna panel simultaneously. At 1302, the process 1300 may further include receiving the PUSCH from the first and second antenna panel according to the DCI.

In various embodiments, the PUSCH transmissions on the first and second antenna panels may include the same or different payloads (e.g., data). The PUSCH transmissions may be multiplexed in at least one of time, frequency, or spatial relation. In some embodiments, the DCI may indicate respective TPMIs and/or SRIs for the transmissions on the first and second antenna panels. Additionally, or alternatively, the gNB may transmit, to the UE, configuration information for the first and second codewords. In some embodiments, the configuration information may indicate respective maximum rank (maxRank) parameters and/or subsets of precoders for the first and second codewords.

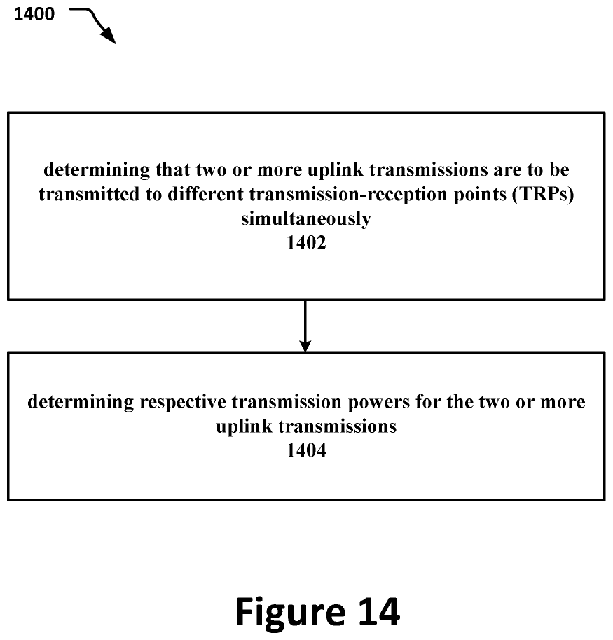

FIG. 14 illustrates another process 1400 in accordance with various embodiments. The process 1400 may be performed by a UE or a portion thereof. At 1402, the process 1400 may include determining that two or more uplink transmissions are to be transmitted to different transmission-reception points (TRPs) simultaneously. At 1404, the process 1400 may further include determining respective transmission powers for the two or more uplink transmissions. For example, the UE may allocate transmission power between the TRPs using semi-static equal power sharing, semi-static unequal power sharing, or dynamic power sharing. A total transmission power of the two or more uplink transmissions may be less than or equal to a maximum transmission power of the UE. In embodiments, the two or more uplink transmissions may be transmitted using respective antenna panels of the UE.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example A1 may include one or more computer-readable media (CRM) having instructions, stored thereon, that when executed by one or more processors of a user equipment (UE), configure the UE to: receive a downlink control information (DCI) to schedule transmission of a physical uplink shared channel (PUSCH) using a first antenna panel and a second antenna panel simultaneously; identify a first codebook to be used for the PUSCH on the first antenna panel; identify a second codebook to be used for the PUSCH on the second antenna panel; and encode the PUSCH for transmission from the first and second antenna panels based on the respective first and second codebooks.

Example A2 may include the one or more CRM of example A1, wherein the DCI indicates a first transmission precoding matrix index (TPMI) for the first codebook and a second TPMI for the second codebook.

Example A3 may include the one or more CRM of example A2, wherein the DCI further indicates a first sounding reference signal (SRS) resource indicator (SRI) for the first codebook and a second SRI for the second codebook.

Example A4 may include the one or more CRM of example A1, wherein the PUSCH transmission on the first antenna panel is multiplexed in one or more of time, frequency, or spatial relation with the PUSCH transmission on the second antenna panel.

Example A5 may include the one or more CRM of example A4, wherein the DCI indicates a first frequency division resource allocation (FDRA) for the PUSCH on the first antenna panel and a second FDRA for the PUSCH on the second antenna panel, or a first time division resource allocation (TDRA) for the PUSCH on the first antenna panel and a second TDRA for the PUSCH on the second antenna panel.

Example A6 may include the one or more CRM of example A1, wherein the DCI indicates that a same or different modulation and coding scheme (MCS), new data indicator (NDI), or redundancy version is to be used for transmission of the PUSCH on the first and second antenna panels.

Example A7 may include the one or more CRM of example A1, wherein the first and second antenna panels are associated with respective demodulation reference signal (DMRS) port groups.

Example A8 may include the one or more CRM of example A1, wherein the instructions, when executed, are further to configure the UE to decode a radio resource control (RRC) message that configures a first maximum rank (maxRank) parameter for the first codeword and a second maxRank parameter for the second codeword.

Example A9 may include the one or more CRM of example A1, wherein the instructions, when executed, are further to configure the UE to decode a radio resource control (RRC) message that configures a first subset of precoders for the first codeword and a second subset of precoders for the second codeword.

Example A10 may include the one or more CRM of any one of examples A1-A9, wherein the PUSCH on the first antenna panel is targeted to a first transmission-reception point (TRP) and the PUSCH on the second antenna panel is targeted to a second TRP.

Example A11 may include the one or more CRM of example A10, wherein the instructions, when executed, are further to configure the UE to allocate transmission power between the first antenna panel and the second antenna panel using semi-static equal power sharing, semi-static unequal power sharing, or dynamic power sharing, wherein a total transmission power of the first and second antenna panels is less than or equal to a maximum transmission power of the UE.

Example A12 may include one or more computer-readable media (CRM) having instructions, stored thereon, that when executed by one or more processors of a next generation Node B (gNB), configure the gNB to:
encode, for transmission to a user equipment (UE), a downlink control information (DCI) to schedule transmission of a physical uplink shared channel (PUSCH) using a first codebook on a first antenna panel and a second codebook on a second antenna panel simultaneously; and
receive the PUSCH from the first and second antenna panel according to the DCI.

Example A13 may include the one or more CRM of example A12, wherein the DCI indicates a first transmission precoding matrix index (TPMI) for the first codebook and a second TPMI for the second codebook.

Example A14 may include the one or more CRM of example A13, wherein the DCI further indicates a first sounding reference signal (SRS) resource indicator (SRI) for the first codebook and a second SRI for the second codebook.

Example A15 may include the one or more CRM of example A12, wherein the PUSCH transmission on the first antenna panel is multiplexed in one or more of time, frequency, or spatial relation with the PUSCH transmission on the second antenna panel.

Example A16 may include the one or more CRM of example A15, wherein the DCI indicates a first frequency division resource allocation (FDRA) for the PUSCH on the first antenna panel and a second FDRA for the PUSCH on the second antenna panel, or a first time division resource allocation (TDRA) for the PUSCH on the first antenna panel and a second TDRA for the PUSCH on the second antenna panel.

Example A17 may include the one or more CRM of example A12, wherein the DCI indicates that a same or different modulation and coding scheme (MCS), new data indicator (NDI), or redundancy version is to be used for transmission of the PUSCH on the first and second antenna panels.

Example A18 may include the one or more CRM of example A12, wherein the first and second antenna panels are associated with respective demodulation reference signal (DMRS) port groups.

Example A19 may include the one or more CRM of example A12, wherein the instructions, when executed, are further to configure the gNB to encode, for transmission to the UE, a radio resource control (RRC) message that configures a first maximum rank (maxRank) parameter for the first codeword and a second maxRank parameter for the second codeword.

Example A20 may include the one or more CRM of example A12, wherein the instructions, when executed, are further to configure the gNB to encode, for transmission to the UE, a radio resource control (RRC) message that configures a first subset of precoders for the first codeword and a second subset of precoders for the second codeword.

Example A21 may include the one or more CRM of any one of examples A12-A20, wherein the PUSCH on the first antenna panel is targeted to a first transmission-reception point (TRP) and the PUSCH on the second antenna panel is targeted to a second TRP.

Example A22 may include the one or more CRM of example A21, wherein the instructions, when executed, are further to configure the gNB to configure the UE to allocate transmission power between the first antenna panel and the second antenna panel using semi-static equal power sharing, semi-static unequal power sharing, or dynamic power sharing, wherein a total transmission power of the first and second antenna panels is less than or equal to a maximum transmission power of the UE.

Example A23 may include an apparatus of a user equipment (UE), the apparatus comprising: a first antenna panel; a second antenna panel; and processor circuitry to: receive configuration information for a first codeword and a second codeword; encode a first PUSCH transmission for transmission on the first antenna panel based on the first codeword; and encode a second PUSCH transmission for transmission on the second antenna panel based on the second codeword, wherein the second PUSCH transmission is at least partially overlapped in the time domain with the first PUSCH transmission.

Example A24 may include the apparatus of example A23, wherein the processor circuitry is further to receive a downlink control information (DCI) to schedule the first and second PUSCH transmissions, wherein the DCI indicates a first transmission precoding matrix index (TPMI) and a first sounding reference signal (SRS) resource indicator (SRI) for the first PUSCH transmission and a second TPMI and a second SRI for the second PUSCH transmission.

Example A25 may include the apparatus of example A23 or A24, wherein the configuration information includes a first maximum rank (maxRank) parameter and a first subset of precoders for the first codeword and a second maxRank parameter and a second subset of precoders for the second codeword.

Example B1 may include a method of a gNB, wherein the gNB could configure the UE with uplink transmission.

Example B2 may include a method of a UE, wherein the UE could support simultaneous transmission over multiple antenna panels.

Example B3 may include the method of example B1 or example B2 or some other example herein, wherein for UE supporting simultaneous uplink transmission from multiple panels, the uplink transmission from multiple UE antenna panels could be TDMed, FDMed or SDMed (or the multiplexing method could be combined, for example, TDMed+FDMed).

Example B4 may include the method of example B1 or example B2 or some other example herein, wherein for UE supporting simultaneous uplink transmission from multiple panels, multiple beams (e.g., 2) could be indicated to the UE for the uplink transmission, e.g., one beam is used for the transmission from one panel. In the DCI scheduling PUSCH transmission (e.g., DCI 0_1/0_2), two beams could be indicated. If the UE supports Rel-16 beam indication, e.g., the beam is indicated by SRI, then two SRI fields should be included in the DCI. If the UE supports Rel-17 TCI operation, then in the DCI scheduling PUSCH (e.g., DCI 0_1/0_2), two TCI states could be indicated by the DCI (The TCI state could be joint DL/UL TCI state or separate UL TCI state). New field(s) should be added in the DCI for TCI indication.

Example B5 may include the method of example B1 or example B2 or some other example herein, wherein for UE supporting simultaneous uplink transmission from multiple panels, single codeword is used for PUSCH. Two SRIs and two TPMIs are indicated to the UE for codebook based transmission. For non-codebook based transmission, two SRI fields are included in the DCI and two SRIs are indicated.

Example B6 may include the method of example B1 or example B2 or some other example herein, wherein for UE supporting simultaneous uplink transmission from multiple panels, multiple codewords, e.g., 2 codewords, could be used for PUSCH. One codeword is used for the transmission over one UE panel. In the DCI two SRIs (for both codebook and non-codebook based transmission) and two TPMIs (for codebook based transmission) are indicated. Two SRI fields and two TPMI fields could be included in the DCI.

Example B7 may include the method of example B1 or example B2 or some other example herein, wherein for the transmission over multiple UE panels, the same frequency/time resource or different frequency/time resource could be used for the transmission over different UE panels. For FDMed transmission from multiple panels, different frequency resources are utilized for the transmission over different panel (or the frequency resources are partially overlapped). One or two FDRA could be indicated by the DCI. One FDRA field could be included in the DCI or two FDRA fields are included in the DCI. Or one FDRA field I is included in the DCI and one codepoint can indicate two FDRA. If two FDRA are indicated by the DCI, then one FDRA is used for the transmission over one panel. If one FDRA is indicated by the DCI, then different parts of the indicated frequency resource are used for different panels.

Example B8 may include the method of example B1 or example B2 or some other example herein, wherein for TDMed transmission from multiple panels, different time resources are utilized for the transmission over different panel (or the time resources are partially overlapped). One or two TDRA could be indicated by the DCI. One TDRA field could be included in the DCI or two TDRA fields are included in the DCI. Or one TDRA field is included in the DCI and one codepoint can indicate two TDRA. If two TDRA are indicated by the DCI, then one TDRA is used for the transmission over one panel. If one TDRA is indicated by the DCI, then different parts of the indicated time resource are used for different panels.

Example B9 may include the method of example B1 or example B2 or some other example herein, wherein for SDMed transmission from multiple panels, the same frequency/time resources are used for the transmission from different panels. Only one FDRA/TDRA is needed. Or the frequency/time resources for different panels could be partially overlapped. In such case, two FDRA/TDRA are indicated.

Example B10 may include the method of example B1 or example B2 or some other example herein, wherein for the transmission from multiple UE panels, the same MCS/NDI/RV could be applied to the transmission from different panel. Or different MCS/NDI/RV could be used for the transmission from different panel. Multiple MCS/NDI/RV fields could be included in the DCI.

Example B11 may include the method of example B1 or example B2 or some other example herein, wherein for the transmission from multiple UE panels, the DMRS port group could be introduced to identify UE antenna panel. For example, two PUSCH DMRS port groups are supported, and one DMRS port group is associated with one UE panel. Or the UE antenna panel could be associated with spatial relation or TCI state. Or the UE antenna panel could be associated with PUSCH close loop power control state. Or different SRS resource set could be configured for different UE panel. And the UE panel is identified by the associated SRS resource set. Or the UE antenna panel could be associated with different SRI.

Example B12 includes a method to be performed by a user equipment (UE) in a wireless network, wherein the method comprises: identifying, by the UE, that a first transmission related to physical uplink shared channel (PUSCH) is to be transmitted from a first antenna panel of an antenna of the UE; identifying, by the UE, that a second transmission related to PUSCH is to be transmitted from a second antenna panel of the antenna of the UE; and transmitting, by the UE, the first transmission over a first time period and the second transmission over a second time period, wherein the first time period and the second time period at least partially overlap in time.

Example B13 includes the method of example B12, or some other example herein, wherein the UE is to transmit the first transmission simultaneously with the second transmission.

Example B14 includes the method of examples B12 or B13, or some other example herein, further comprising multiplexing, by the UE, the first transmission with the second transmission.

Example B15 includes the method of example B14, or some other example herein, wherein the multiplexing is one or more of frequency division multiplexing (FDM), time division multiplexing (TDM), and space division multiplexing (SDM).

Example B16 includes the method of any of examples B12-B15, or some other example herein, further comprising identifying, by the UE, a beam indication in a downlink transmission, wherein the beam indication indicates a first beam to be used by the UE for the first transmission and a second beam to be used by the UE for the second transmission.

Example B17 includes the method of example B16, or some other example herein, wherein the beam indication includes one or more of downlink control information (DCI), transmission configuration indicator (TCI), and sounding reference signal (SRS) resource indicator (SRI).

Example B18 includes the method of any of examples B12-B16, or some other example herein, further comprising: identifying, by the UE, a codeword; and transmitting, by the UE, the first transmission and the second transmission in accordance with the codeword.

Example B19 includes the method of any of examples B12-B16, or some other example herein, further comprising: identifying, by the UE, a first codeword and a second codeword; transmitting, by the UE, the first transmission in accordance with the first codeword; and transmitting, by the UE, the second transmission in accordance with the second codeword.

Example B20 includes the method of any of examples B12-B19, or some other example herein, wherein the first transmission and the second transmission use a same time and/or frequency resource.

Example B21 includes the method of any of examples B12-B19, or some other example herein, wherein the first transmission and the second transmission use different time/frequency resources.

Example C1 may include a method of a gNB, wherein the gNB could configure the UE with uplink transmission.

Example C2 may include the method of example C1 or some other example herein, wherein for uplink transmission up to 8 Tx, single codeword is used. the value of RRC parameter maxRank should be extended up to 8. Correspondingly, the value of maxMIMO-Layers should also be extended to 8. Only one maxRank parameter (also only one maxMIMO-Layers) is configured to the UE, and only one codebook subset is configured to the UE.

Example C3 may include the method of example C1 or some other example herein, wherein for uplink transmission up to 8 Tx, multiple codewords (e.g., 2) are used.

Example C4 may include the method of example C3 or some other example herein, wherein two RRC parameter maxRank (also two maxMIMO-Layers) could be configured, one for each codeword. The value of the two maxRank parameters (and two maxMIMO-Layers) could be the same or different.

Example C5 may include the method of example C3 or some other example herein, wherein only one maxMIMO-Layers is configured, which indicates the maximum number of MMO layers across all the codewords (or it is indicated by a new RRC parameter). The parameter maxRank is used to indicate the maximum number of layers for each codeword (or it is indicated by a new RRC parameter), and the value of maxRank could be equal to or smaller than maxMIMO-Layers. One or two maxRank could be configured. If only one maxRank is configured, then it applies to all the codewords. If two maxRank are configured, then one is used for each codeword, and the value of the two maxRank could be the same or different.

Example C6 may include the method of example C3 or some other example herein, wherein Two codebook subsets could be configured to the UE, one for each codeword. The same or different codebook subset could be configured for different codeword. The type of the codebook subset (full coherent, partial coherent, non-coherent) could be the same or different for different codeword. Alternatively, only one codebook subset is configured to the UE, which is applicable for all the codewords.

Example C7 may include the method of example C3 or some other example herein, wherein the number of antenna ports could be the same or different for different codeword.

Example C8 may include the method of example C3 or some other example herein, wherein for uplink transmission up to 8 Tx, if multiple codewords (e.g., 2) are used, then only one RRC parameter maxRank (also only one maxMIMO-Layers) is configured, which is used for all the codewords. And only one codebook subset is configured to the UE, which is used for all the codewords.

Example C9 may include a method of a UE, wherein the UE could support simultaneous uplink transmission from multiple UE panels (e.g., 2 panels).

Example C10 may include the method of example C1 or example C9 or some other example herein, wherein two RRC parameter maxRank (also two maxMIMO-Layers) could be configured, one for each panel (or one for each codeword, if two codewords are used). The value of the two maxRank parameters (and two maxMIMO-Layers) could be the same or different.

Example C11 may include the method of example C1 or example C9 or some other example herein, wherein only one maxMIMO-Layers is configured, which indicates the maximum number of MMO layers across all the panels/codewords (or it is indicated by a new RRC parameter). The parameter maxRank is used to indicate the maximum number of layers for each panel/codeword (or it is indicated by a new RRC parameter), and the value of maxRank could be equal to or smaller than maxMIMO-Layers. One or two maxRank could be configured. If only one maxRank is configured, then it applies to all the panels/codewords. If two maxRank are configured, then one is used for each panel/codeword, and the value of the two maxRank could be the same or different.

Example C12 may include the method of example C1 or example C9 or some other example herein, wherein Two codebook subsets could be configured to the UE, one for each panel (or one for each codeword, if two codewords are used). The same or different codebook subset could be configured for different panel/codeword. The type of the codebook subset (full coherent, partial coherent, non-coherent) could be the same or different for different panel/codeword. Alternatively, only one codebook subset is configured to the UE, which is applicable for all the panels.

Example C13 may include the method of example C1 or example C9 or some other example herein, wherein the number of antenna ports could be the same or different for different panel/codeword.

Example C14 may include the method of example C1 or example C9 or some other example herein, wherein only one RRC parameter maxRank (also only one maxMIMO-Layers) is configured, which is used for all the panels/codewords. And only one codebook subset is configured to the UE, which is used for all the panels/codewords.

Example C15 includes a method to be performed by a user equipment (UE) in a wireless network, the method comprising: identifying, by the UE, that a physical uplink shared channel (PUSCH) transmission is to be transmitted using up to 8 transmit layers; identifying, by the UE, a number of codewords to be used to transmit the PUSCH transmission; identifying, by the UE based on the number of codewords, a value for a maxRank radio resource control (RRC) parameter and a value for a maxMIMO-Layers RRC parameter; and transmitting, by the UE, the PUSCH transmission based on the number of transmit layers, the number of codewords, the value for the maxRank RRC parameter, and the value for the maxMIMO-Layers RRC parameter.

Example C16 includes the method of example C15, or some other example herein, wherein the number of transmit layers is between 5 and 8.

Example C17 includes the method of examples C15 or C16, or some other example herein, wherein the number of codewords is 1.

Example C18 includes the method of example C17, or some other example herein, wherein the value of maxRank is between 5 and 8.

Example C19 includes the method of example C17, or some other example herein, wherein the value of maxMIMO-Layers is between 5 and 8.

Example C20 includes the method of examples C15 or C16, or some other example herein, wherein the number of codewords is 2.

Example C21 includes the method of example C20, or some other example herein, wherein the first codeword is associated with a first maxRank parameter and a first maxMIMO-Layers parameter, and the second codeword is associated with a second maxRank parameter and a second maxMIMO-Layers parameter.

Example C22 includes the method of example C21, or some other example herein, wherein the first max Rank parameter has a same value as the second maxRank parameter, and the first maxMIMO-Layers parameter has a same value as the second maxMIMO-Layers parameter.

Example C23 includes the method of example C21, or some other example herein, wherein the first max Rank parameter has a different value than the second maxRank parameter, and the first maxMIMO-Layers parameter has a different value than the second maxMIMO-Layers parameter.

Example C24 includes the method of example C20, or some other example herein, wherein a maxRank parameter is shared between the two codewords.

Example C25 includes the method of example C20, or some other example herein, wherein a maxMIMO-Layers parameter is shared between the two codewords.

Example C26 includes a method to be performed by a user equipment (UE) in a wireless network, the method comprising: identifying, by the UE, that the UE is to transmit a first uplink (UL) transmission from a first antenna panel of an antenna of the UE; identifying, by the UE, that the UE is to transmit a second UL transmission from a second antenna panel of the antenna at a time that at least partially overlaps a time in which the first UL transmission is to occur; identifying, by the UE, a radio resource control (RRC) maxRank parameter and a RRC maxMIMO-Layers parameter; and transmitting, by the UE, at least one of the first UL transmission and the second UL transmission based on the maxRank parameter and the maxMIMO-Layers parameter.

Example C27 includes the method of example C26, or some other example herein, wherein the first UL transmission is associated with a first maxRank parameter and a first maxMIMO-Layers parameter, and the second UL transmission is associated with a second maxRank parameter and a second maxMIMO-Layers parameter.

Example C28 includes the method of example C27, or some other example herein, wherein the first max Rank parameter has a same value as the second maxRank parameter, and the first maxMIMO-Layers parameter has a same value as the second maxMIMO-Layers parameter.

Example C29 includes the method of example C27, or some other example herein, wherein the first max Rank parameter has a different value than the second maxRank parameter, and the first maxMIMO-Layers parameter has a different value than the second maxMIMO-Layers parameter.

Example C30 includes the method of example C26, or some other example herein, wherein the first UL transmission and the second UL transmission use a same maxRank parameter.

Example C31 includes the method of example C26, or some other example herein, wherein the first UL transmission and the second UL transmission use a same RRC maxMIMO-Layers parameter.

Example C32 includes the method of any of examples C26-C31, or some other example herein, wherein the first UL transmission is associated with a first codebook subset and the second UL transmission is associated with a second codebook subset.

Example C33 includes the method of example C32, or some other example herein, wherein the first codebook subset may have a different coherency than a coherency of the second codebook subset.

Example C34 includes the method of any of examples C26-C31, or some other example herein, wherein the first and second UL transmissions share a same codebook subset.

Example D1 may include a method of power control mechanisms for simultaneous multi-TRP UL transmission, wherein the method includes:
semi-static equal power sharing,
semi-static unequal power sharing, and/or
dynamic power sharing.

Example D2 may include a method of PHR reporting mechanisms for simultaneous multi-TRP UL transmission, wherein the method includes the scenarios of
semi-static equal power sharing,
semi-static unequal power sharing,
dynamic power sharing,
simultaneous PUSCH repetitions, and/or
simultaneous PUSCH transmissions.

Example D3 may include a method of a user equipment (UE), the method comprising: determining that two or more uplink transmissions are to be transmitted to different transmission-reception points (TRPs) simultaneously; and determining respective transmission powers for the two or more uplink transmissions.

Example D4 may include the method of example D3 or some other example herein, further comprising transmitting the two or more uplink transmissions in accordance with the determined transmission powers.

Example D5 may include the method of example D3-D4 or some other example herein, wherein determining the respective transmission powers includes determining a first transmission power based on a first maximum transmission power and determining a second transmission power based on a second maximum transmission power, wherein the first and second maximum transmission powers are less than a total maximum transmission power for uplink transmissions.

Example D6 may include the method of example D5 or some other example herein, wherein the first and second maximum transmission powers are equal.

Example D7 may include the method of example D6 or some other example herein, wherein the first and second maximum transmission powers are 1/X of the total maximum transmission power, wherein X is a total number of the two or more uplink transmissions that are to be transmitted simultaneously.

Example D8 may include the method of example D5 or some other example herein, wherein the second maximum transmission power is different than the first maximum transmission power.

Example D9 may include the method of example D5-D8 or some other example herein, further comprising receiving configuration information to indicate respective values of the first and second maximum transmission powers.

Example D10 may include the method of example D5 or some other example herein, wherein a sum of the first and second maximum transmission powers is greater than the total maximum transmission power.

Example D11 may include the method of example D5, D10 or some other example herein, wherein the second transmission power is determined after determination of the first transmission power and based on the determined first transmission power.

Example D12 may include the method of example D11 or some other example herein, wherein the first transmission power is for a first uplink transmission to be transmitted to a primary TRP.

Example D13 may include the method of example D12 or some other example herein, further comprising receiving an indication of the primary TRP.

Example D14 may include the method of example D11-D13 or some other example herein, further comprising determining not to transmit the second uplink transmission based on the determined second transmission power.

Example D15 may include the method of example D3-D14 or some other example herein, further comprising encoding a power headroom report for transmission based on the determined transmission powers.

Example D16 may include the method of example D15 or some other example herein, wherein the power headroom report includes a plurality of power headrooms corresponding to transmissions toward the respective TRPs.

Example D17 may include the method of example D15 or some other example herein, wherein respective power headroom reports are transmitted to the different TRPs, wherein the individual power headroom reports include a single power headroom that corresponds to the target TRP.

Example D18 may include the method of example D15-D17 or some other example herein, wherein respective power headroom reports are transmitted to the different TRPs, and wherein the power headroom reports each include a power headroom that corresponds to a total remaining transmission power of the UE.

Example Z01 may include an apparatus comprising means to perform one or more elements of a method described in or related to any of examples A1-A25, B1-21, C1-C34, D1-D18, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A25, B1-21, C1-C34, D1-D18, or any other method or process described herein.

Example Z03 may include an apparatus comprising logic, modules, or circuitry to perform one or more elements of a method described in or related to any of examples A1-A25, B1-21, C1-C34, D1-D18, or any other method or process described herein.

Example Z04 may include a method, technique, or process as described in or related to any of examples A1-A25, B1-21, C1-C34, D1-D18, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A25, B1-21, C1-C34, D1-D18, or portions thereof.

Example Z06 may include a signal as described in or related to any of examples A1-A25, B1-21, C1-C34, D1-D18, or portions or parts thereof.

Example Z07 may include a datagram, packet, frame, segment, protocol data unit (PDU), or message as described in or related to any of examples A1-A25, B1-21, C1-C34, D1-D18, or portions or parts thereof, or otherwise described in the present disclosure.

Example Z08 may include a signal encoded with data as described in or related to any of examples A1-A25, B1-21, C1-C34, D1-D18, or portions or parts thereof, or otherwise described in the present disclosure.

Example Z09 may include a signal encoded with a datagram, packet, frame, segment, protocol data unit (PDU), or message as described in or related to any of examples A1-A25, B1-21, C1-C34, D1-D18, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A25, B1-21, C1-C34, D1-D18, or portions thereof.

Example Z11 may include a computer program comprising instructions, wherein execution of the program by a processing element is to cause the processing element to carry out the method, techniques, or process as described in or related to any of examples A1-A25, B1-21, C1-C34, D1-D18, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACR | Application Context |
| | Relocation |
| ACK | Acknowledgement |
| ACID | Application |
| | Client Identification |
| AF | Application Function |
| AM | Acknowledged Mode |
| AMBR | Aggregate Maximum |
| | Bit Rate |
| AMF | Access and Mobility |
| | Management Function |
| AN | Access Network |
| ANR | Automatic Neighbour |
| | Relation |
| AOA | Angle of Arrival |
| AP | Application Protocol, |
| | Antenna Port, |
| | Access Point |
| API | Application |
| | Programming Interface |
| APN | Access Point Name |
| ARP | Allocation and |
| | Retention Priority |
| ARQ | Automatic |
| | Repeat Request |
| AS | Access Stratum |
| ASP | Application Service |
| | Provider |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam Failure Detection |
| BLER | Block Error Rate |
| BPSK | Binary Phase Shift |
| | Keying |
| BRAS | Broadband Remote |
| | Access Server |
| BSS | Business Support System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based |
| | Random Access |
| CC | Component Carrier, |
| | Country Code, |
| | Cryptographic |
| | Checksum |
| CCA | Clear Channel |
| | Assessment |
| CCE | Control Channel |
| | Element |
| CCCH | Common Control |
| | Channel |
| CE | Coverage Enhancement |
| CDM | Content Delivery Network |
| CDMA | Code-Division |
| | Multiple Access |
| CDR | Charging Data Request |
| CDR | Charging Data Response |
| CFRA | Contention Free |
| | Random Access |
| CG | Cell Group |
| CGF | Charging Gateway |
| | Function |
| CHF | Charging Function |
| CI | Cell Identity |
| CID | Cell-ID (e.g., |
| | positioning method) |
| CIM | Common Information |
| | Model |
| CIR | Carrier to |
| | Interference Ratio |
| CK | Cipher Key |
| CM | Connection Management, |
| | Conditional Mandatory |
| CMAS | Commercial Mobile |
| | Alert Service |
| CMD | Command |
| CMS | Cloud Management |
| | System |
| CO | Conditional Optional |
| CoMP | Coordinated Multi-Point |
| CORESET | Control Resource Set |
| COTS | Commercial Off- |
| | The-Shelf |
| CP | Control Plane, Cyclic |
| | Prefix, Connection |
| | Point |
| CPD | Connection Point |
| | Descriptor |
| CPE | Customer Premise |
| | Equipment |
| CPICH | Common Pilot Channel |
| CQI | Channel Quality |
| | Indicator |
| CPU | CSI processing unit, |
| | Central Processing Unit |
| C/R | Command/Response |
| | field bit |
| CRAN | Cloud Radio Access |
| | Network, Cloud RAN |
| CRB | Common Resource |
| | Block |
| CRC | Cyclic Redundancy |
| | Check |
| CRI | Channel-State |
| | Information Resource |
| | Indicator, CSI-RS |
| | Resource Indicator |
| C-RNTI | Cell RNTI |
| CS | Circuit Switched |
| CSCF | call session control |
| | function |
| CSAR | Cloud Service Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI signal-to-noise |
| | and interference ratio |
| CSMA | Carrier Sense Multiple |
| | Access |
| CSMA/CA | CSMA with collision |
| | avoidance |
| CSS | Common Search Space, |
| | Cell-specific |
| | Search Space |
| CTF | Charging |
| | Trigger Function |
| CTS | Clear-to-Send |
| CW | Codeword |
| CWS | Contention Window |
| | Size |
| D2D | Device-to-Device |
| DC | Dual Connectivity, |
| | Direct Current |
| DCI | Downlink Control |
| | Information |
| DF | Deployment Flavour |
| DL | Downlink |
| DMTF | Distributed |
| | Management Task |
| | Force |
| DPDK | Data Plane |
| | Development Kit |
| DM-RS, DMRS | Demodulation |
| | Reference Signal |
| DN | Data network |
| DNN | Data Network |
| | Name |
| DNAI | Data Network Access |
| | Identifier |
| DRB | Data Radio Bearer |
| DRS | Discovery Reference |
| | Signal |
| DRX | Discontinuous |
| | Reception |
| DSL | Domain Specific |
| | Language. Digital |
| | Subscriber Line |
| DSLAM | DSL Access |
| | Multiplexer |
| DwPTS | Downlink Pilot Time |
| | Slot |
| E-LAN | Ethernet |
| | Local Area Network |
| E2E | End-to-End |
| EAS | Edge Application |
| | Server |
| ECCA | extended clear |
| | channel assessment, |
| | extended CCA |
| ECCE | Enhanced Control |
| | Channel Element, |
| | Enhanced CCE |
| ED | Energy Detection |
| EDGE | Enhanced |
| | Datarates for GSM |
| | Evolution (GSM |
| | Evolution) |
| EAS | Edge |
| | Application Server |
| EASID | Edge Application |
| | Server Identification |
| ECS | Edge |
| | Configuration Server |
| ECSP | Edge Computing |
| | Service Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge Hosting |
| | Environment |
| EGMF | Exposure Governance |
| | Management |
| | Function |
| EGPRS | Enhanced GPRS |
| EIR | Equipment Identity |
| | Register |
| eLAA | enhanced Licensed |
| | Assisted Access, |
| | enhanced LAA |
| EM | Element Manager |
| eMBB | Enhanced Mobile |
| | Broadband |
| EMS | Element |
| | Management System |
| eNB | evolved NodeB, |
| E-UTRAN | Node B |
| EN-DC | E-UTRA-NR Dual |
| | Connectivity |
| EPC | Evolved Packet Core |
| EPDCCH | enhanced PDCCH, |
| | enhanced Physical |
| | Downlink Control |
| | Cannel |
| EPRE | Energy per |
| | resource element |
| EPS | Evolved Packet System |
| EREG | enhanced REG, |
| | enhanced resource |
| | element groups |
| ETSI | European |
| | Telecommunications |
| | Standards Institute |
| ETWS | Earthquake and |
| | Tsunami Warning |
| | System |
| eUICC | embedded UICC, |
| | embedded Universal |
| | Integrated Circuit |
| | Card |
| E-UTRA | Evolved UTRA |
| E-UTRAN | Evolved UTRAN |
| EV2X | Enhanced V2X |
| F1AP | F1 Application Protocol |
| F1-C | F1 Control plane |
| | interface |
| F1-U | F1 User plane interface |
| FACCH | Fast Associated Control |
| | CHannel |
| FACCH/F | Fast Associated Control |
| | Channel/Full rate |
| FACCH/H | Fast Associated Control |
| | Channel/Half rate |
| FACH | Forward Access |
| | Channel |
| FAUSCH | Fast Uplink |
| | Signalling Channel |
| FB | Functional Block |
| FBI | Feedback Information |
| FCC | Federal |
| | Communications |
| | Commission |
| FCCH | Frequency |
| | Correction CHannel |
| FDD | Frequency |
| | Division Duplex |
| FDM | Frequency Division |
| | Multiplex |
| FDMA | Frequency Division |
| | Multiple Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified |
| | Domain Name |
| G-RNTI | GERAN Radio |
| | Network Temporary |
| | Identity |
| GERAN | GSM EDGE |
| | RAN, GSM EDGE |
| | Radio Access Network |
| GGSN | Gateway GPRS |
| | Support Node |
| GLONASS | GLObal'naya |
| | NAvigatsionnaya |
| | Sputnikovaya |
| | Sistema (Engl.: |
| | Global Navigation |
| | Satellite System) |
| gNB | Next Generation NodeB |
| gNB-CU | gNB-centralized unit, |
| | Next Generation NodeB |
| | centralized unit |
| gNB-DU | gNB-distributed |
| | unit, Next Generation |
| | NodeB distributed unit |
| GNSS | Global Navigation |
| | Satellite System |
| GPRS | General Packet |
| | Radio Service |
| GPSI | Generic Public |
| | Subscription Identifier |
| GSM | Global System for |
| | Mobile Communications, |
| | Groupe Spécial Mobile |
| GTP | GPRS Tunneling |
| | Protocol |
| GTP-UGPRS | Tunnelling Protocol |
| | for User Plane |
| GTS | Go To Sleep Signal |
| | (related to WUS) |
| GUMMEI | Globally |
| | Unique MME Identifier |
| GUTI | Globally Unique |
| | Temporary UE Identity |
| HARQ | Hybrid ARQ, |
| | Hybrid Automatic |
| | Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land |
| | Mobile Network |
| HSDPA | High Speed Downlink |
| | Packet Access |
| HSN | Hopping |
| | Sequence Number |
| HSPA | High Speed |
| | Packet Access |
| HSS | Home Subscriber Server |
| HSUPA | High Speed Uplink |
| | Packet Access |
| HTTP | Hyper Text |
| | Transfer Protocol |
| HTTPS | Hyper Text Transfer |
| | Protocol Secure (https is |
| | http/1.1 over |
| | SSL, i.e. port 443) |
| I-Block | Information Block |
| ICCID | Integrated Circuit Card |
| | Identification |
| IAB | Integrated |
| | Access and Backhaul |
| ICIC | Inter-Cell |
| | Interference Coordination |
| ID | Identity, identifier |
| IDFT | Inverse Discrete Fourier |
| | Transform |
| IE | Information element |
| IBE | In-Band Emission |
| IEEE | Institute of |
| | Electrical and |
| | Electronics Engineers |
| IEI | Information |
| | Element Identifier |
| IEIDL | Information Element |
| | Identifier Data Length |
| IETF | Internet Engineering |
| | Task Force |
| IF | Infrastructure |
| IIOT | Industrial |
| | Internet of Things |
| IM | Interference |
| | Measurement, |
| | Intermodulation, |
| | IP Multimedia |
| IMC | IMS Credentials |
| IMEI | International Mobile |
| | Equipment Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, |
| | Internet Protocol |
| | Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services |
| | Identity Module |
| ISO | International |
| | Organisation for |
| | Standardisation |
| ISP | Internet Service |
| | Provider |
| IWF | Interworking-Function |
| I-WLAN | Interworking WLAN |
| | Constraint length |
| | of the convolutional |
| | code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key Performance |
| | Indicator |
| KQI | Key Quality Indicator |
| KSI | Key Set Identifier |
| ksps | kilo-symbols per |
| | second |
| KVM | Kernel Virtual |
| | Machine |
| L1 | Layer 1 (physical layer) |
| L1-RSRP | Layer 1 reference signal |
| | received power |
| L2 | Layer 2 (data link |
| | layer) |
| L3 | Layer 3 (network layer) |
| LAA | Licensed Assisted |
| | Access |
| LAN | Local Area Network |
| LADN | Local Area Data |
| | Network |
| LBT | Listen Before Talk |
| LCM | LifeCycle |
| | Management |
| LCR | Low Chip Rate |
| LCS | Location Services |
| LCID | Logical Channel ID |
| LI | Layer Indicator |
| LLC | Logical Link Control, |
| | Low Layer |
| | Compatibility |
| LMF | Location |
| | Management Function |
| LOS | Line of Sight |
| LPLMN | Local PLMN |
| LPP | LTE Positioning |
| | Protocol |
| LSB | Least Significant Bit |
| LTE | Long Term Evolution |
| LWA | LTE-WLAN |
| | aggregation |
| LWIP | LTE/WLAN Radio |
| | Level Integration with |
| | IPsec Tunnel |
| LTE | Long Term |
| | Evolution |
| M2M | Machine-to-Machine |
| MAC | Medium Access |
| | Control (protocol |
| | layering context) |
| MAC | Message |
| | authentication code |
| | (security/encryption |
| | context) |
| MAC-A | MAC used for |
| | authentication and key |
| | agreement (TSG |
| | T WG3 context) |
| MAC-IMAC | used for data integrity |
| | of signalling messages |
| | (TSG T WG3 context) |
| MANO | Management and |
| | Orchestration |
| MBMS | Multimedia Broadcast |
| | and Multicast Service |
| MBSFN | Multimedia Broadcast |
| | multicast service |
| | Single |
| | Frequency Network |
| MCC | Mobile Country Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error Ratio |
| MGL | Measurement |
| | Gap Length |
| MGRP | Measurement |
| | Gap Repetition Period |
| MIB | Master Information |
| | Block, Management |
| | Information Base |
| MIMO | Multiple Input |
| | Multiple Output |
| MLC | Mobile Location Centre |
| MM | Mobility Management |
| MME | Mobility |
| | Management Entity |
| MN | Master Node |
| MNO | Mobile Network Operator |
| MO | Measurement Object, |
| | Mobile Originated |
| MPBCH | MTC Physical |
| | Broadcast CHannel |
| MPDCCH | MTC Physical Downlink |
| | Control CHannel |
| MPDSCH | MTC Physical Downlink |
| | Shared CHannel |
| MPRACH | MTC Physical Random |
| | Access CHannel |
| MPUSCH | MTC Physical Uplink |
| | Shared Channel |
| MPLS | MultiProtocol |
| | Label Switching |
| MS | Mobile Station |
| MSB | Most Significant Bit |
| MSC | Mobile Switching Centre |
| MSI | Minimum System |
| | Information, MCH |
| | Scheduling Information |
| MSID | Mobile Station Identifier |
| MSIN | Mobile Station |
| | Identification Number |
| MSISDN | Mobile Subscriber ISDN |
| | Number |
| MT | Mobile Terminated, |
| | Mobile Termination |
| MTC | Machine-Type |
| | Communications |
| mMTC | massive MTC, massive |
| | Machine-Type |
| | Communications |
| MU-MIMO | Multi User MIMO |
| MWUS | MTC wake-up signal, |
| | MTC WUS |
| NACK | Negative |
| | Acknowledgement |
| NAI | Network Access |
| | Identifier |
| NAS | Non-Access Stratum, |
| | Non-Access Stratum layer |
| NCT | Network Connectivity |
| | Topology |
| NC-JT | Non-Coherent Joint |
| | Transmission |
| NEC | Network Capability |
| | Exposure |
| NE-DC | NR-E-UTRA |
| | Dual Connectivity |
| NEF | Network Exposure Function |
| NF | Network Function |
| NFP | Network Forwarding Path |
| NFPD | Network Forwarding Path |
| | Descriptor |
| NFV | Network Functions |
| | Virtualization |
| NFVI | NFV Infrastructure |
| NFVO | NFV Orchestrator |
| NG | Next Generation, |
| | Next Gen |
| NGEN-DC | NG-RAN |
| | E-UTRA-NR Dual |
| | Connectivity |
| NM | Network Manager |
| NMS | Network Management |
| | System |
| N-PoP | Network Point |
| | of Presence |
| NMIB, N-MIB | Narrowband MIB |
| NPBCH | Narrowband Physical |
| | Broadcast CHannel |
| NPDCCH | Narrowband Physical |
| | Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband Primary |
| | Synchronization Signal |
| NSSS | Narrowband Secondary |
| | Synchronization Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection Assistance |
| | Information |
| S-NNSAI | Single-NSSAI |
| NSSF | Network Slice |
| | Selection Function |
| NW | Network |
| NWUS | Narrowband |
| | wake-up signal, |
| | Narrowband WUS |
| NZP | Non-Zero Power |
| O&M | Operation and |
| | Maintenance |
| ODU2 | Optical channel |
| | Data Unit-type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations |
| | Support System |
| OTA | over-the-air |
| PAPR | Peak-to-Average |
| | Power Ratio |
| PAR | Peak to Average Ratio |
| PBCH | Physical Broadcast |
| | Channel |
| PC | Power Control, |
| | Personal Computer |
| PCC | Primary Component |
| | Carrier, Primary CC |
| P-CSCF | Proxy CSCF |
| PCell | Primary Cell |
| PCI | Physical Cell ID, |
| | Physical Cell Identity |
| PCEF | Policy and Charging |
| | Enforcement Function |
| PCF | Policy Control Function |
| PCRF | Policy Control and |
| | Charging Rules Function |
| PDCP | Packet Data |
| | Convergence Protocol, |
| | Packet Data |
| | Convergence |
| | Protocol layer |
| PDCCH | Physical Downlink |
| | Control Channel |
| PDCP | Packet Data |
| | Convergence Protocol |
| PDN | Packet Data Network, |
| | Public Data Network |
| PDSCH | Physical Downlink |
| | Shared Channel |
| PDU | Protocol Data Unit |
| PEI | Permanent Equipment |
| | Identifiers |
| PFD | Packet Flow |
| | Description |
| P-GW | PDN Gateway |
| PHICH | Physical hybrid-ARQ |
| | indicator channel |
| PHY | Physical layer |
| PLMN | Public Land |
| | Mobile Network |
| PIN | Personal |
| | Identification Number |
| PM | Performance |
| | Measurement |
| PMI | Precoding |
| | Matrix Indicator |
| PNF | Physical |
| | Network Function |
| PNFD | Physical |
| | Network Function |
| | Descriptor |
| PNFR | Physical |
| | Network Function |
| | Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block |
| | group |
| ProSe | Proximity Services, |
| | Proximity-Based |
| | Service |
| PRS | Positioning Reference |
| | Signal |
| PRR | Packet Reception |
| | Radio |
| PS | Packet Services |
| PSBCH | Physical Sidelink |
| | Broadcast Channel |
| PSDCH | Physical Sidelink |
| | Downlink Channel |
| PSCCH | Physical Sidelink |
| | Control Channel |
| PSSCH | Physical Sidelink |
| | Shared Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical Uplink |
| | Control Channel |
| PUSCH | Physical Uplink |
| | Shared Channel |
| QAM | Quadrature Amplitude |
| | Modulation |
| QCI | QoS class of |
| | identifier |
| QCL | Quasi co-location |
| QFI | QoS Flow ID, |
| | QoS Flow Identifier |
| QoS | Quality of Service |
| QPSK | Quadrature |
| | (Quaternary) Phase |
| | Shift Keying |
| QZSS | Quasi-Zenith Satellite |
| | System |
| RA-RNTI | Random Access RNTI |
| RAB | Radio Access Bearer, |
| | Random Access Burst |
| RACH | Random Access |
| | Channel |
| RADIUS | Remote Authentication |
| | Dial In User Service |
| RAN | Radio Access Network |
| RAND | RANDom |
| | number (used for |
| | authentication) |
| RAR | Random Access |
| | Response |
| RAT | Radio Access |
| | Technology |
| RAU | Routing Area Update |
| RB | Resource block, |
| | Radio Bearer |
| RBG | Resource block |
| | group |
| REG | Resource |
| | Element Group |
| Rel | Release |
| REQ | REQuest |
| RF | Radio Frequency |
| RI | Rank Indicator |
| RIV | Resource |
| | indicator value |
| RL | Radio Link |
| RLC | Radio Link |
| | Control, Radio |
| | Link Control layer |
| RLC AM | RLC |
| | Acknowledged Mode |
| RLC UM | RLC |
| | Unacknowledged Mode |
| RLF | Radio Link Failure |
| RLM | Radio Link |
| | Monitoring |
| RLM-RS | Reference Signal |
| | for RLM |
| RM | Registration |
| | Management |
| RMC | Reference |
| | Measurement Channel |
| RMSI | Remaining MSI, |
| | Remaining Minimum |
| | System Information |
| RN | Relay Node |
| RNC | Radio Network |
| | Controller |
| RNL | Radio Network |
| | Layer |
| RNTI | Radio Network |
| | Temporary Identifier |
| ROHC | RObust Header |
| | Compression |
| RRC | Radio Resource |
| | Control, Radio |
| | Resource Control layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time Protocol |
| RTS | Ready-To-Send |
| RTT | Round Trip Time |
| Rx | Reception, Receiving, |
| | Receiver |
| S1AP | S1 Application |
| | Protocol |
| S1-MME | S1 for the control plane |
| S1-U | S1 for the user plane |
| S-CSCF | serving CSCF |
| S-GW | Serving Gateway |
| S-RNTI | SRNC Radio Network |
| | Temporary Identity |
| S-TMSI | SAE |
| | Temporary Mobile |
| | Station Identifier |
| SA | Standalone |
| | operation mode |
| SAE | System Architecture |
| | Evolution |
| SAP | Service Access Point |
| SAPD | Service Access Point |
| | Descriptor |
| SAPI | Service Access Point |
| | Identifier |
| SCC | Secondary |
| | Component Carrier, |
| | Secondary CC |
| SCell | Secondary Cell |
| SCEF | Service Capability |
| | Exposure Function |
| SC-FDMA | Single Carrier |
| | Frequency Division |
| | Multiple Access |
| SCG | Secondary Cell Group |
| SCM | Security Context |
| | Management |
| SCS | Subcarrier Spacing |
| SCTP | Stream Control |
| | Transmission |
| | Protocol |
| SDAP | Service Data |
| | Adaptation Protocol, |
| | Service Data |
| | Adaptation |
| | Protocol layer |
| SDL | Supplementary |
| | Downlink |
| SDNF | Structured Data |
| | Storage Network |
| | Function |
| SDP | Session Description |
| | Protocol |
| SDSF | Structured Data |
| | Storage Function |
| SDT | Small Data |
| | Transmission |
| SDU | Service Data Unit |
| SEAF | Security Anchor |
| | Function |
| SeNB | secondary eNB |
| SEPP | Security Edge |
| | Protection Proxy |
| SFI | Slot format indication |
| SFTD | Space-Frequency |
| | Time Diversity, |
| | SFN and frame |
| | timing difference |
| SFN | System Frame |
| | Number |
| SgNB | Secondary gNB |
| SGSN | Serving GPRS |
| | Support Node |
| S-GW | Serving Gateway |
| SI | System Information |
| SI-RNTI | System Information |
| | RNTI |
| SIB | System Information |
| | Block |
| SIM | Subscriber Identity |
| | Module |
| SIP | Session Initiated |
| | Protocol |
| SiP | System in Package |
| SL | Sidelink |
| SLA | Service Level |
| | Agreement |
| SM | Session Management |
| SMF | Session Management |
| | Function |
| SMS | Short Message Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling Request |
| SRB | Signalling Radio |
| | Bearer |
| SRS | Sounding |
| | Reference Signal |
| SS | Synchronization Signal |
| SSB | Synchronization |
| | Signal Block |
| SSID | Service Set Identifier |
| SS/PBCH Block | SSBRI |
| | SS/PBCH Block |
| | Resource Indicator, |
| | Synchronization |
| | Signal Block |
| | Resource Indicator |
| SSC | Session and |
| | Service Continuity |
| SS-RSRP | Synchronization |
| | Signal based |
| | Reference Signal |
| | Received Power |
| SS-RSRQ | Synchronization |
| | Signal based |
| | Reference Signal |
| | Received Quality |
| SS-SINR | Synchronization |
| | Signal based Signal |
| | to Noise and |
| | Interference Ratio |
| SSS | Secondary |
| | Synchronization |
| | Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary |
| | Uplink |
| TA | Timing Advance, |
| | Tracking Area |
| TAC | Tracking Area |
| | Code |
| TAG | Timing Advance |
| | Group |
| TAI | Tracking |
| | Area Identity |
| TAU | Tracking Area Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal |
| | Equipment |
| TEID | Tunnel End |
| | Point Identifier |
| TFT | Traffic Flow |
| | Template |
| TMSI | Temporary Mobile |
| | Subscriber Identity |
| TNL | Transport |
| | Network Layer |
| TPC | Transmit Power |
| | Control |
| TPMI | Transmitted |
| | Precoding Matrix |
| | Indicator |
| TR | Technical Report |
| TRP, TRxP | Transmission |
| | Reception Point |
| TRS | Tracking |
| | Reference Signal |
| TRx | Transceiver |
| TS | Technical |
| | Specifications, |
| | Technical |
| | Standard |
| TTI | Transmission |
| | Time Interval |
| Tx | Transmission, |
| | Transmitting, |
| | Transmitter |
| U-RNTI | UTRAN Radio |
| | Network Temporary |
| | Identity |
| UART | Universal Asynchronous |
| | Receiver and |
| | Transmitter |
| UCI | Uplink Control |
| | Information |
| UE | User Equipment |
| UDM | Unified Data |
| | Management |
| UDP | User Datagram Protocol |
| UDSF | Unstructured Data |
| | Storage Network |
| | Function |
| UICC | Universal Integrated |
| | Circuit Card |
| UL | Uplink |
| UM | Unacknowledged |
| | Mode |
| UML | Unified |
| | Modelling Language |
| UMTS | Universal Mobile |
| | Telecommunications |
| | System |
| UP | User Plane |
| UPF | User Plane Function |
| URI | Uniform |
| | Resource Identifier |
| URL | Uniform |
| | Resource Locator |
| URLLC | Ultra-Reliable and Low |
| | Latency |
| USB | Universal Serial Bus |
| USIM | Universal Subscriber |
| | Identity Module |
| USS | UE-specific search |
| | space |
| UTRA | UMTS Terrestrial |
| | Radio Access |
| UTRAN | Universal Terrestrial |
| | Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized |
| | Infrastructure Manager |
| VL | Virtual Link, |
| VLAN | Virtual LAN, Virtual |
| | Local Area Network |
| VM | Virtual Machine |
| VNF | Virtualized |
| | Network Function |
| VNFFG | VNF Forwarding |
| | Graph |
| VNFFGD | VNF Forwarding |
| | Graph Descriptor |
| VNFM | VNF Manager |
| VoIP | Voice-over-IP, |
| | Voice-over-Internet |
| | Protocol |
| VPLMN | Visited Public |
| | Land Mobile Network |
| VPN | Virtual Private |
| | Network |
| VRB | Virtual Resource Block |
| WiMAX | Worldwide |
| | Interoperability for |
| | Microwave Access |
| WLAN | Wireless Local |
| | Area Network |
| WMAN | Wireless Metropolitan |
| | Area Network |
| WPAN | Wireless |
| | Personal Area Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes.

Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-25. (canceled)

26. One or more non-transitory computer-readable media (NTCRM) having instructions, stored thereon, that when executed by one or more processors of a user equipment (UE), configure the UE to:
receive a downlink control information (DCI) to schedule transmission of a physical uplink shared channel (PUSCH) using a first antenna panel and a second antenna panel simultaneously;
identify a first codebook to be used for the PUSCH on the first antenna panel;
identify a second codebook to be used for the PUSCH on the second antenna panel; and
encode the PUSCH for transmission from the first and second antenna panels based on the respective first and second codebooks.

27. The one or more NTCRM of claim 26, wherein the DCI indicates a first transmission precoding matrix index (TPMI) for the first codebook and a second TPMI for the second codebook.

28. The one or more NTCRM of claim 27, wherein the DCI further indicates a first sounding reference signal (SRS) resource indicator (SRI) for the first codebook and a second SRI for the second codebook.

29. The one or more NTCRM of claim 26, wherein the PUSCH transmission on the first antenna panel is multiplexed in one or more of time, frequency, or spatial relation with the PUSCH transmission on the second antenna panel.

30. The one or more NTCRM of claim 29, wherein the DCI indicates a first frequency division resource allocation (FDRA) for the PUSCH on the first antenna panel and a second FDRA for the PUSCH on the second antenna panel, or a first time division resource allocation (TDRA) for the PUSCH on the first antenna panel and a second TDRA for the PUSCH on the second antenna panel.

31. The one or more NTCRM of claim 26, wherein the DCI indicates that a same or different modulation and coding scheme (MCS), new data indicator (NDI), or redundancy version is to be used for transmission of the PUSCH on the first and second antenna panels; or
wherein the first and second antenna panels are associated with respective demodulation reference signal (DMRS) port groups.

32. The one or more NTCRM of claim 26, wherein the instructions, when executed, further configure the UE to decode a radio resource control (RRC) message that configures a first maximum rank (maxRank) parameter for the first codeword and a second maxRank parameter for the second codeword.

33. The one or more NTCRM of claim 26, wherein the instructions, when executed, further configure the UE to decode a radio resource control (RRC) message that configures a first subset of precoders for the first codeword and a second subset of precoders for the second codeword.

34. The one or more NTCRM of claim 26, wherein the PUSCH on the first antenna panel is targeted to a first transmission-reception point (TRP) and the PUSCH on the second antenna panel is targeted to a second TRP, and wherein the instructions, when executed, further configure the UE to allocate transmission power between the first antenna panel and the second antenna panel using semi-static equal power sharing, semi-static unequal power sharing, or dynamic power sharing, wherein a total transmission power of the first and second antenna panels is less than or equal to a maximum transmission power of the UE.

35. One or more non-transitory computer-readable media (NTCRM) having instructions, stored thereon, that when executed by one or more processors of a next generation Node B (gNB), configure the gNB to:
encode, for transmission to a user equipment (UE), a downlink control information (DCI) to schedule transmission of a physical uplink shared channel (PUSCH) using a first codebook on a first antenna panel and a second codebook on a second antenna panel simultaneously; and
receive the PUSCH from the first or second antenna panel according to the DCI.

36. The one or more NTCRM of claim 35, wherein the DCI indicates a first transmission precoding matrix index (TPMI) for the first codebook and a second TPMI for the second codebook.

37. The one or more NTCRM of claim 36, wherein the DCI further indicates a first sounding reference signal (SRS) resource indicator (SRI) for the first codebook and a second SRI for the second codebook.

38. The one or more NTCRM of claim 35, wherein the PUSCH transmission on the first antenna panel is multiplexed in one or more of time, frequency, or spatial relation with the PUSCH transmission on the second antenna panel.

39. The one or more NTCRM of claim 38, wherein the DCI indicates a first frequency division resource allocation (FDRA) for the PUSCH on the first antenna panel and a second FDRA for the PUSCH on the second antenna panel, or a first time division resource allocation (TDRA) for the PUSCH on the first antenna panel and a second TDRA for the PUSCH on the second antenna panel.

40. The one or more NTCRM of claim 35, wherein the DCI indicates that a same or different modulation and coding scheme (MCS), new data indicator (NDI), or redundancy version is to be used for transmission of the PUSCH on the first and second antenna panels; or
wherein the first and second antenna panels are associated with respective demodulation reference signal (DMRS) port groups.

41. The one or more NTCRM of claim 35, wherein the instructions, when executed, further configure the gNB to encode, for transmission to the UE, a radio resource control (RRC) message that configures:
a first maximum rank (maxRank) parameter for the first codeword and a second maxRank parameter for the second codeword; or
a first subset of precoders for the first codeword and a second subset of precoders for the second codeword.

42. The one or more NTCRM of claim 35, wherein the PUSCH on the first antenna panel is targeted to a first transmission-reception point (TRP) and the PUSCH on the second antenna panel is targeted to a second TRP, and wherein the instructions, when executed, further configure the gNB to configure the UE to allocate transmission power between the first antenna panel and the second antenna panel using semi-static equal power sharing, semi-static unequal power sharing, or dynamic power sharing, wherein a total transmission power of the first and second antenna panels is less than or equal to a maximum transmission power of the UE.

43. An apparatus of a user equipment (UE), the apparatus comprising:
a first antenna panel;
a second antenna panel; and
processor circuitry to:
decode configuration information for a first codeword and a second codeword;
encode a first PUSCH transmission for transmission on the first antenna panel based on the first codeword; and
encode a second PUSCH transmission for transmission on the second antenna panel based on the second codeword, wherein the second PUSCH transmission is at least partially overlapped in the time domain with the first PUSCH transmission.

44. The apparatus of claim 43, wherein the processor circuitry is further to decode a downlink control information (DCI) to schedule the first and second PUSCH transmissions, wherein the DCI indicates a first transmission precoding matrix index (TPMI) and a first sounding reference signal (SRS) resource indicator (SRI) for the first PUSCH transmission and a second TPMI and a second SRI for the second PUSCH transmission.

45. The apparatus of claim 43, wherein the configuration information includes a first maximum rank (maxRank) parameter and a first subset of precoders for the first codeword and a second maxRank parameter and a second subset of precoders for the second codeword.
